(19) United States
(12) Patent Application Publication
(10) Pub. No.: US 2024/0121572 A1
(43) Pub. Date: Apr. 11, 2024

(54) WIRELESS COMMUNICATION SYSTEM FOR FIRST RESPONDER NETWORKS

(71) Applicant: KONINKLIJKE PHILIPS N.V., Eindhoven (NL)

(72) Inventors: Vignesh Raja Karuppiah Ramachandran, Mol (BE); Jozef Hubertus Gelissen, Herten (NL); Franciscus Antonius Maria Van De Laar, Veldhoven (NL); Walter Dees, Eindhoven (NL); Joseph E Rock, Littleton, MA (US)

(21) Appl. No.: 18/276,487

(22) PCT Filed: Feb. 10, 2022
(86) PCT No.: PCT/EP2022/053191

§ 371 Date: Aug. 9, 2023

Related U.S. Application Data
(60) Provisional application No. 63/148,237, filed on Feb. 11, 2021.

(30) Foreign Application Priority Data
Aug. 16, 2021 (EP) 21191552.5

(51) Int. Cl. H04W 4/021; H04W 60/04

(52) U.S. Cl. CPC H04W 4/021; H04W 60/04; H04W 4/90

(57) ABSTRACT

A first responder network is a network that is used by first responders for communicating between devices typically used by first responding officers. An MCI describes an incident in which emergency medical services are overwhelmed by the number and severity of casualties. A wireless communication system for first responder networks is proposed that can securely register (onboard) a variety of wireless devices to ensure a quicker response time in the MCI area. Existing wireless devices belonging to both triage officers and casualties in the MCI area can automatically be registered to a first responder network to enhance coverage in the MCI area. Expansion of a wireless infrastructure of the first responder network can be enabled by securely registering alien central nodes (e.g., base stations) on an on-demand basis.

### FIELD OF THE INVENTION

The invention relates to an establishment of a first responder network in wireless network environments, such as—but not limited to—cellular networks with indirect network connections for remote communication devices.

### BACKGROUND OF THE INVENTION

Natural disasters, such as earthquakes, hurricanes, tsunamis, rock slides, forest fires, and tropical storms can cause a great deal of damage, and can result in loss of human life. Other non-natural disasters, such as building fires, some forest fires, a building collapsing, and a terrorist attack, can similarly cause damage and loss of life. In some cases, the amount of damage and/or loss of life that results from a disaster can be reduced through improved response systems.

A mass casualty incident (MCI) describes an incident in which emergency medical services may potentially be overwhelmed by the number and severity of casualties. Triaging is a process applied when there are more casualties requiring aid than there are medical personnel available. Examples of these situations are mass-transportation accidents and terrorism.

Currently, tools that care providers use during an MCI event are relatively low tech, i.e., paper based systems. Digital technology has been proposed to increase triage speed and have a better overview of the status of an MCI event as well as change the current static paper-based information to dynamic digital information. By doing so, logistics of clinical and non-clinical operations in an MCI event can be improved and real-time patient monitoring can be introduced by incorporating vital sign sensors.

However, the use of digital technology requires coverage for communication purposes to exchange data between wireless communication devices present locally on the scene either in a peer-to-peer fashion (e.g., mesh network) or in a server-client fashion (e.g., via a serving Wi-Fi access point).

One issue that often occurs during an MCI event is the overload of regular telecommunication networks. To avoid emergency medical services no longer able to communicate, countries have set up dedicated communication networks for this purpose, like FirstNet of the First Responder Network Authority in the United States and C2000 in the Netherlands. Unfortunately, it is often reported that even these networks do not work reliably.

Another issue is that during an MCI event that is caused by a perpetrator (e.g., terrorism), the perpetrator can intentionally overload and interrupt the publicly available telecommunication network. Alternatively, a natural MCI event (e.g., tsunami) can disrupt the public infrastructure of regular telecommunication networks, e.g., by damaging base stations of cellular communication network and backhaul links.

### SUMMARY OF THE INVENTION

It is an object of the present invention to enable improved service provision in MCI areas.

This object is achieved by an apparatus as claimed in claim 1, by an access device as claimed in claim 7, by a wireless communication system as claimed in claim 8, by a method as claimed in claim 16, and by a computer program product as claimed in claim 17.

According to a first aspect related to an access device end of the communication link, an apparatus is provided for supporting establishment of a wireless communication network (for example for use by the first responders), wherein the apparatus is configured to:
connect to a network controller device of the wireless network and provide wireless connectivity to wireless communication devices within a target geographical area;
receive information about the target geographical area;
receive from the network controller device information about the network configuration to setup communication channel with wireless communication devices; and
invite wireless communication devices located in the target geographical area to register via the communication channel or other communication channel to the core network operated by the network controller device.

The first aspect is related to access devices (such as drones), where the information about the target geographical area/space (e.g., a two-dimensional (2D) area or three-dimensional (3D) volume (indicated by a set of 2D/3D coordinates) with a cluster of casualties, or a best landmark location for the access device to be stationed in the MCI area) may be received directly from a network controller device or via other access devices and/or a separate positioning server. Also, the network controller device could use a 3rd party positioning application programming interface (API) to provide or to calculate this information for the access device, e.g., though a network exposure function (NEF) of the network controller device. In an example, an access device which did not receive the information about target geographical area yet could directly receive this information from a 3rd party API/NEF via other (e.g., non-3GPP) communication methods (e.g., Wi-Fi) on request of the network controller device. This is advantageous in that an access device that is far away and has lost connection to the network controller device can still be relocated within the target geographical area.

Thus, the information about the target geographical area of the MCI area may be received directly from a network controller device or via other wireless communication devices, access devices, or a separate positioning server. Details needed to calculate the information about the target geographical area for the access devices (such as SLAM sensor data, signal quality information etc.) may be sent to the network controller device from the access device and wireless communication devices in the MCI area.

The information about the network configuration to setup a communication channel with wireless communication devices may include information to configure and/or can be used to authorize the access device to invite wireless communication devices to a specific slice/frequency of the network in the MCI area. The network configuration information may contain e.g. an authorization for an access device to invite wireless communication devices or additional access devices in the area to connect to the core network, network/slice specific settings (such as frequency, allowed devices, services offered, Restricted Local Operator Services (RLOS), steering of roaming, emergency/non-emergency slice indication), credentials (e.g. private key) needed to authorize wireless communication device of a first responder.

Pre-authorized wireless communication devices may respond to the invitation by establishing a secure channel using the credentials (e.g. public key) pre-stored in the wireless communication device to connect via the access device to the wireless communication network and/or a specific network slice. In an example, wireless communication devices capable of proving their authenticity may be allowed to connect to the “first responder” slice. Devices not proving the authenticity may be steered to connect to a “non-first-responder” slice.

According to a second aspect related to the access device end of the communication link, a method of supporting establishment of a wireless communication network (for first responders) is provided, wherein the method comprises:
connecting to a network controller device of the wireless communication network and providing wireless connectivity to wireless communication devices within a target geographical area;
receiving information about the target geographical area;
receiving from the network controller device information about the network configuration to setup communication channel with wireless communication devices; and
inviting wireless communication devices located in the target geographical area to register via the communication channel or other communication channel to the core network operated by the network controller device.

According to a third aspect, an access device for providing wireless connectivity to wireless communication devices in a wireless communication network (for first responders) is provided, the access device comprising an apparatus of the first aspect.

According to a fourth aspect, a wireless communication system is provided, comprising a network controller device, one or more wireless communication devices, and an access device of the third aspect connected to the network controller device.

Finally, according to an fifth aspect, a computer program product is provided, which comprises code means for producing the steps of the above methods of the third or fourth aspect when run on a computer device.

Accordingly, a wireless communication system for first responder networks or other public and non-public wireless (emergency) networks can be provided that can securely register a variety of wireless devices to ensure a quicker response time e.g. in an MCI or other emergency area. In case of an MCI event, existing wireless devices belonging to both triage officers and casualties in the MCI area can automatically be registered to a first responder network to enhance coverage in the MCI area. Moreover, the wireless communication network is enabled to authorize access devices to send invitations to wireless communication devices for connecting to the wireless communication network.

According to a first option which may be combined with any of the above first to fifth aspects, a detected wireless communication device that is a predetermined wireless communication device of a first responder may be prevented from connecting to another wireless network (e.g. a public network from a different operator) during an MCI or other emergency event (e.g. by receiving corresponding prioritized access list or steering of roaming information, or temporary disabling steering of roaming based on an instruction); and/or a detected wireless communication device that is a not a predetermined wireless communication device of a first responder may be prevented from registering onto the wireless first responder network (e.g. by receiving corresponding access control or allowed/rejected slice information). Thereby, the number of wireless communication devices allowed to communicate (e.g. in an MCI or other emergency area) and their scope of communication can be controlled to ensure sufficient service capacity. As a further option, only a limited set of services (e.g. only voice services and/or limited data services) could be allowed as part of the default slice, so that bystanders cannot flood the network with video streams of the event.

Furthermore, a wireless communication device which is normally allowed to connect to another wireless network (e.g. a public network from a different operator) could be controlled by temporarily updating steering of roaming information or similarly by updating the prioritized list of preferred Non-Public Networks. to connect to the first responder network, e.g., by removing those networks or giving the wireless first responder network a higher priority. To this end, the steering of roaming or prioritized list of Non-Public Networks information may be accompanied or is signed with security credentials that may indicate an emergency situation or an MCI event. As a further option, policies for connecting to a network (e.g., at which minimal signal strength to connect) may be updated. Upon leaving the MCI area, the old steering of roaming/prioritized list of Non-Public Networks may be restored. This could be done by temporarily backing up the old steering of roaming/prioritized list of Non-Public Networks or giving the wireless first responder network only a temporary higher priority, e.g., based on an expiration timer so that when the expiration timer expires the higher priority network is removed.

It is to be noted that the information about the target geographical area may be received at the apparatus of the first aspect. In a specific example, the target geographical area may be an area smaller than the coverage area of an access device.

According to a second option which may be combined with the first option or any of the above first to fifth aspects, a total number of access devices needed in a target geographical area and their location in the target area may be predicted based on measurement parameters received from the access devices and access devices may be deployed or removed based on the prediction result. Thus, the coverage required for sufficient service capacity in the target geographical area can be ensured.

According to a third option which can be combined with the first or second option or any of the above first to fifth aspects, it may be checked whether the detected wireless communication device is a predetermined wireless communication device of a first responder by verifying an identification information linked to a user of the detected wireless communication device or an identification information linked to a pre-registered first responder device. Thereby, communication in an MCI or emergency area can be restricted to selected wireless communication devices to ensure sufficient service capacity. As a further option, first responder devices could be registered to a separate slice and/or separate frequency of the first responder network, separated from casualties and/or audience.

According to a fourth option which can be combined with any of the first to third options or any of the above first to fifth aspects, one or more additional access devices can be authorized and registered (i.e. coupled) to the wireless communication network (for first responders), either directly or via an access device that has already been coupled before, e.g. by exchanging emergency related security credentials or security credentials indicative of a first responder during registration. If access devices are mobile (e.g. drones with built-in base station functionality), each of these access devices may receive coordinates from a network controller device to move towards the respective coordinate. In addition, a base station device that belongs to a Public Land Mobile Network (PLMN) that operates in the same or partially overlapping area may be requested/invited (either via a signal (indicative of an emergency) transmitted by an access device of the wireless first responder network, or via a backend connection between the network controller device of the wireless first responder network and the PLMN), and subsequently authorized and registered to operate as an additional access device of the first responder network. This measure ensures that communication with emergency services can be provided by the wireless first responder network by providing sufficient coverage e.g. within an MCI or emergency area.

According to a fifth option which can be combined with any of the first to fourth options or any of the above first to fifth aspects, identity information of a wireless communication device belonging to e.g. a casualty in an MCI or emergency area may be fetched and the casualty may be identified by matching the identity information of the wireless communication device to a user information stored in a cellular device platform, or the wireless communication device of the casualty may be registered to the wireless communication network (for first responders) to triangulate the location of the casualty. Thereby, casualties can be identified and/or located in the MCI or emergency area.

According to a sixth option which can be combined with any of the first to fifth options or any of the above first to fifth aspects, registration invitations may be restricted to at least one of a predetermined group and/or type of the wireless communication devices, a network service and a network slice of the wireless communication network. Thereby, wireless devices used in an MCI or emergency area can be restricted to specific groups or types or services or network slices to ensure reliable and effective service provision in the MCI or emergency area.

According to a seventh option which can be combined with any of the first to sixth options or any of the above first to fifth aspects, access devices deployed in target geographical area (e.g. an MCI or emergency area) may comprise a relay node function that can be activated by the network controller device. This measure provides the advantage that the network controller device can activate relay node functions to enhance the coverage area of the first responder network in an MCI or emergency area, e.g., through a multi-hop chain of access devices. Additionally, the wireless communication devices connected to the access devices may be activated to operate as relay nodes to extend the coverage of the wireless communication network.

According to an eighth option which can be combined with any of the first to seventh options or any of the above first to fifth aspects, measurements may be performed by deployed access devices in their target geographical areas (e.g. an MCI or emergency area) and corresponding measurement parameters may be forwarded to the network controller device for prediction of a total number of access devices needed in the MCI or emergency area. Thereby, it can be ensured that an adequate number of access devices is deployed in the MCI or emergency area to ensure reliable and effective service provision in the MCI or emergency area. Such measurements may also be performed by other wireless devices, e.g. in areas where access devices do not provide coverage and only relayed connection is possible.

According to a ninth option which can be combined with any of the first to eighth options or any of the above first to fifth aspects, a first responder database may be provided for pre-registering wireless communication devices in association with a respective first responder, and a central identity server may be provided that is configured to access the first responder database to derive user information of a first responder associated with a pre-registered wireless communication device. Thereby, device identification information of detected wireless communication devices can be used to check whether the detected wireless communication devices belong to a pre-registered first responder that is allowed to use the first responder network for communication.

According to a tenth option which can be combined with any of the first to ninth options or any of the above first to fifth aspects, the apparatus of the first aspect may be further configured to include information (e.g., a special information element) about an emergency situation in an invitation signal or message sent to the wireless communication devices and which may further include credentials (e.g. digital certificate signed by a first responder organization or the government) indicating the emergency nature of the request.

According to an eleventh option which can be combined with any of the first to tenth options or any of the above first to fifth aspects, the system of the fourth aspect may be configured to provide device authentication via a coupling between the network controller device and an external device not registered to the wireless communication network (for first responders). Thereby, non-registered wireless communication devices can be registered to the wireless communication network without extensive pre-registration effort.

In an example of the eleventh option, the network controller device of the system of the fourth aspect may be configured to connect to the external device over a local connection limited in range and provide a coupling to a core network of the wireless communication network (for first responders) in order to allow the external device to act as authenticator and/or a subscription owner registry for an inbound roaming device.

In another example of the eleventh option, the network controller device of the system of the fourth aspect may be configured to allow the external device to prove that an incoming roaming device belongs to a same network, facility or group.

In a further example of the eleventh option, the network controller device of the system of the fourth aspect may be configured to provide authentication and/or identification information to the external device (e.g. a drone or other wireless robotic device or a mobile server device located e.g. on fire truck of another fire brigade), so that a core network function of the external device can provide a local network registration function.

According to a twelfth option which can be combined with any of the first to eleventh options or any of the above first to eighth aspects, the system of the seventh aspect may be configured to exchange information between the wireless communication network (for first responders) and another wireless communication network (e.g. a PLMN operated by a public network operator) for user identification, acquiring position information, or to request an access device of the another wireless communication network to temporarily join the first responder network.

According to a thirteenth option which can be combined with any of the first to twelfth options or any of the above first to fifth aspects, the system of the fourth aspect may be configured to identify and keep track of legitimate network authorizations and transactions in the wireless communication network and/or subscriber databases, e.g., to provide proper deregistration of all the access devices and wireless communication devices, restore the devices to their previous state, and to keep a log of what has happened (e.g. for training purposes, or in case of dealing with liability, i.e. as a black box).

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the access device of claim 7, the wireless communication system of claim 8, the method of claim 16, and the computer program product of claim 17 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows an MCI scenario in which the present invention can be implemented;

FIG. 2 schematically shows an architecture of a first responder network according to various embodiments;

FIG. 3 schematically shows a block diagram of a network controller device according to various embodiments;

FIG. 4 schematically shows a block diagram of an access device according to various embodiments;

FIG. 5 schematically shows a flow diagram of a first responder network deployment procedure according to various embodiments; and

FIG. 6 schematically shows a flow diagram of a first responder network localization and mapping procedure according to various embodiments.

### DETAILED DESCRIPTION OF EMBODIMENTS

Embodiments of the present invention are now described based on a network infrastructure aimed for example at first responders that comprises an end-to-end wireless system that may be deployed at an MCI event or other event in which (e.g. emergency) personnel may require a network infrastructure to provide communication (e.g. forest fire or emergency situation in a remote area, without reliable network coverage, temporary event including a large gathering and for which n alternative network for the personnel is required). Even though the embodiments of the present invention are described based on a first responder network, the invention and techniques in the invention are not restricted to first responder networks and can apply to any cellular Public Land Mobile Network (PLMN) or any cellular or non-cellular Non-Public Network (NPN).

The system can be deployed on demand based on dynamics of location and specifics of the MCI event (e.g., if the MCI event is a terrorist attack, a minor or a major road accident, natural disaster, or a pandemic etc.), each of which can have their own requirements by first responders depending on the number of victims and the area surrounding the incident. Medical service vehicles, such as ambulances and fire trucks, could be outfitted with antennas for wireless communication technologies such as (but not limited to) cellular base station with direct satellite link, WIFI, Bluetooth, Long Range (LoRa) and the like.

Throughout the present disclosure, a “first responder” is meant to be a person who is among the first to arrive and provide assistance at the scene of an emergency in an MCI event, such as an accident, natural disaster, or terrorism. First responders may include law enforcement officers, paramedics, emergency medical technicians (EMT's) and firefighters. In some areas, emergency department personnel may also be required to respond to disasters and critical situations, designating them first responders. Furthermore, a “first responder network” is meant to be a dedicated network for use by first responders to support their services in an MCI area. A first responder network may typically be a dedicated/standalone non-public network, but may also be a network that shares infrastructure with a public network or incorporates public network functions.

Reasons not to use existing communication networks can be overload (typically when something happens people start using communication systems to get and spread information), unavailability of the network (especially when considering large, disastrous MCI's, such as an earthquake, plane crash in a living area or metro station, communication systems can simply be destroyed or the signal may be unable to penetrate to such locations), and unlawful intent to disrupt known and public network services by a perpetrator in a MCI event (e.g., jamming a certain radio frequency range during a terrorist attack).

As already mentioned above, there are several first responder networks such as FirstNet, which is deployed in all fifty states of the US. Although these types of first responder networks typically operate on a dedicated non-public radio frequency (RF) spectrum to reduce interference from the general public during an MCI event, they cannot be automatically deployed and operated independently without existing cellular infrastructure.

Alternatively, non-commercial networks such as amateur radio are frequently used during disasters. However, such networks are not very reliable for performing high bandwidth, low latency communication. Moreover, additional hardware is necessary for the user to indulge in amateur radio communication.

Furthermore, cell on wings (COW) has been proposed, in which drones are used to automatically deploy a preconfigured network infrastructure with direct satellite link. However, such COW systems are heavily pre-configured with specific network information, only suitable for areas where there is no cellular coverage and are not dynamically configurable based on specific characteristics of an MCI event.

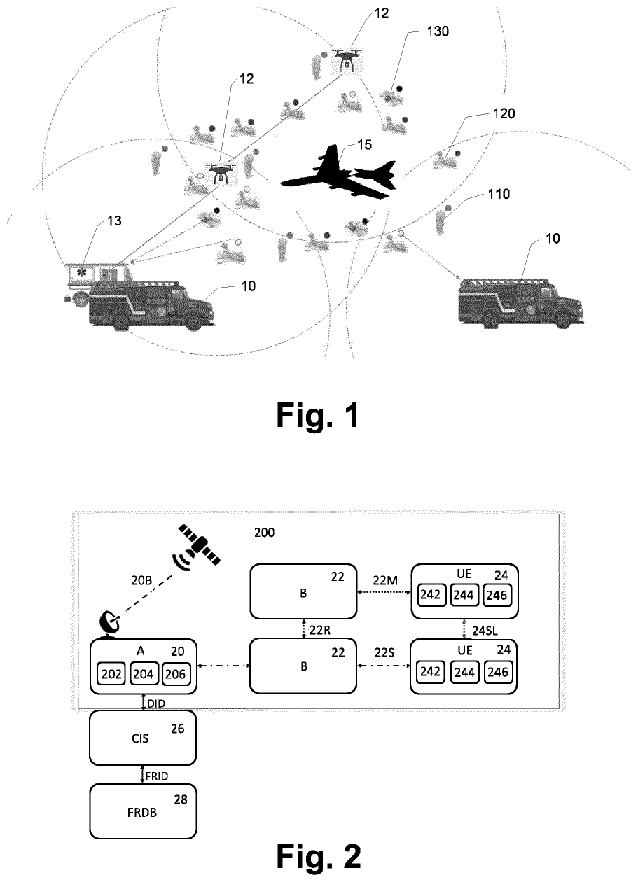

FIG. 1 schematically shows an MCI scenario in which the present invention can be implemented.

More specifically, the MCI scenario of FIG. 1 relates to a crashed airplane 15 with first responders (e.g., triage officers) 110 and triaged casualties (i.e., victims or patients) 120, 130.

In various embodiments, emergency vehicles, such as firetrucks 10 and ambulance or medical service vehicles 13, are outfitted with their own first responder network infrastructure with dedicated backhaul communication facilities (e.g., satellite antenna) that can automatically be deployed with minimal configuration to be fully operational as a stand-alone wireless first responder network that can particularly serve the MCI area. The wireless first responder network may have its own limited range to prevent interference from/to other public networks outside the MCI area.

In certain situations where the MCI event happens in a large area, the emergency vehicles 10, 13 may however be unable to provide full coverage. In FIG. 1, triaged casualties 120, 130 inside the dashed circles around the emergency vehicles 10, 13 are in the range of the two first responder networks established by the emergency vehicles 10, 13. However, the emergency vehicles 10, 13 are unable to cover the entire MCI area because they cannot reach certain places.

Other examples of non-sufficient coverage are an underground (metro) incident, an incident near or at a mountain, a swamp or a coast.

To support and/or extend the coverage area of an established first responder network, a variety of devices (e.g., wireless communication devices such as user equipment (UE) of casualties or first responders (e.g., triage officers), smart watches, cellular medical devices, etc.) that are present in the MCI area may act as relays in the first responder network.

Furthermore, the infrastructure of the wireless first responder network can be extended by adding a base station device (e.g., equipped on a drone from a different first responding service) that is unknown to the deployed wireless first responder network, which can be onboarded as a part of the deployed first responder network.

Furthermore, unmanned, either remote controlled or autonomous robots such as the drones and/or motorized rovers already have wide-spread applications, such as military use, races, light shows, video and photography to deliver packages, inspecting communication lines on the bottom of the ocean and even fighting insect plagues like grasshoppers in Africa. Such unmanned robots are cost-efficient and potentially can be programmed to be either controlled remotely or entirely automated to navigate in unprecedented locations like an MCI area.

As shown in FIG. 1, drones 12 or other autonomous robots can be used to monitor and expand the MCI area of the emergency vehicle 10, 13. The network expansion can be achieved by deploying the drones 12 as relay nodes with own coverage areas (dotted circles around the drones 12). As shown in FIG. 1, the lower one of the drones 12 is located in the left coverage area of the emergency vehicles 10, 13 of FIG. 1 and is operated as a relay node of the first responder network, while the upper one of the drones 12 is located in the coverage area of the lower one (relay node) of the drones 12.

Additionally or alternatively, existing and capable cellular devices (e.g., mobile phones) or other wireless devices (not shown in FIG. 1) may be improvised and/or automatically repurposed to enhance the coverage area of the first responder network.

FIG. 2 schematically shows an architecture of a first responder network 200 according to various embodiments based on a wireless communication system (e.g., a Public Land Mobile Network (PLMN) or a Non-Public Network (NPN)).

In FIG. 2, a network controller device (device A) 20 is configured to operate a core network for the first responder network 200, which may be deployed standalone, to offer a temporary network for first responders and casualties at an MCI event and may optionally be connected to other core networks of one or more mobile operators. It may comprise a network controller module or function 202, an identity service module or function 204 and a simultaneous localization and mapping (SLAM) module or function 206, a Location Service (LCS) or location database, and other core network modules/functions (such as Access and Mobility Function (AMF), Mobility Management Entity (MME), Unified Data Management function (UDM) or Home Subscriber server (HSS), Authentication Server Function (AUSF). The functionality of these modules/functions may be combined, e.g. the SLAM module/function 206 may be combined with a Location Service (LCS), or e.g. an identity service module or function 204 may for example be a separate identity manager/database combined with an AUSF or UDM, but may also be an AUSF combined with UDM, or simply function as an AUSF, an Authentication/Authorization/Accounting AAA server, or equivalent.

It is however noted that in all embodiments the core network may be distributed across multiple devices and does not have to be a single device.

Furthermore, one or more base station or access devices (device B) 22 are connected to the device A 20 and capable of providing wireless connectivity to wireless communication devices 24 (device UE) within their coverage area. The device identity (e.g., subscription concealed identity (SUCI) in 5G network) of the one or more devices UE 24 can be concealed with secure credentials (e.g. private key) of the home PLMN of the device UE 24.

The device A 20 may be able to automatically connect to a central identity server (CIS) 26 to communicate subscriber details, such as a device identification (DID) (e.g., IMSI) of a first responder and fetch information of a user linked to a targeted device UE 24. Such central identity server (CIS) 26 may be external to the core network of the first responder network 200, e.g. deployed as an external AAA server or RADIUS server, or an AUSF in another network (e.g. the home network of the target device UE 24).

Additionally, a first responder database (FRDB) 28 may be provided, which can be used to pre-register at least some of the devices UE 24 to their respective first responders for verification purposes and/or to specific network slices. Such first responder database (FRDB) 28 may for example be an Active Directory Server or UDM in another network (e.g. the home network of the target device UE 24) To enable authentication of the device UE 24 with the first responder network 200, e.g. through the identity service module/function 204, and/or central identity server 26 and/or with the First Responder DataBase and/or the home network of the device, the device UE 24 may have a secure device identity (devID) or user identity (userID) stored in a secure memory (e.g., international mobile equipment identity (IMEI)) which is unique to the device UE 24 or to the user (e.g. digital passport) and can be coupled to a user of the device via a network related information (e.g., international mobile subscription identity (IMSI) stored in the subscriber identification module 242 (e.g., as described in GSMA SGP.21—RSP Architecture). In case of an NPN, TLS/certificate/PKI based credentials could be used, e.g. as described in TS 33.501, and/or a concept of default credentials could be used, as described in 3GPP specification TR 23.700-07.

The CIS 26 may be configured to access the first responder database 28 to derive user information (e.g., a first responder ID (FRID)) of a registered first responder associated with a device UE 24.

In an embodiment, the device A 20 may invite the device UE 24 or may trigger/request the device to connect to the first responder network 200, after de-concealing the concealed device identity (e.g., to derive a subscription permanent identifier (SUPI) from the SUCI) by requesting the home PLMN (e.g. at the Subscription Identifier De-Concealing Function (SIDF) in 5G network via NEF) of the device UE 24. To this end, the first responder network 200, e.g. through the AUSF, may need to provide credentials (e.g. a digital certificate signed by a first responder agency or the government) with which it can prove to the home PLMN of device UE 24 that it involves an emergency situation and that hence it is important to provide device/user identity information of device UE 24 (e.g. based on SUCI that may be provided by the responder network to the home PLMN) and/or for device UE 24 to connect to the first responder network to set up the necessary communication. Alternatively, upon device UE 24 registering to the first responder network, the first responder network may request the home PLMN of device UE 24 if device UE 24 is allowed or can be allowed/enabled to register to the first responder network without requesting deconcealment of the SUPI. In this alternative, the first responder network may need to provide emergency credentials to the home PLMN of device UE 24 as described above (e.g. in case no roaming agreement is in place). In another alternative, upon device UE 24 registering to the first responder network, the first responder network may request the home PLMN of device UE 24 to provide user identity related information (e.g. subscription information, name of subscription owner of the subscription linked to the respective SUPI, telephone number, emergency contacts, electronic health record information) and/or location information of device UE 24, with/without requesting further permission of device UE 24 to register to the first responder network. In this alternative, the first responder network may need to provide emergency credentials to the home PLMN of device UE 24 as described above. Communication from the first responder network 200 to the home PLMN in order to make the above mentioned requests and for the home PLMN to provide its responses may be done in a secure channel with or without a roaming agreement in emergency scenarios.

To this end, device A 20 or another device of the first responder network may need to connect to the NEF of the home PLMN of device UE 24 and present the emergency credential which can then after verification by the home PLMN to be genuine (e.g. by contacting the respective certificate authority that signed the certificate) be used in a security handshake to set up a secure connection (e.g. IPSec tunnel) between the first responder network and the home PLMN. Alternatively, device A or another device of the first responder networks may register as a UE with the home Network and e.g. request a PDU session through which it may provide the emergency credentials, and use this to set up a secure connection to allow the first responder network (e.g. its AUSF) to request the home PLMN to de-conceal the device identity and/or allow the device UE 24 to register to the first responder network. The registration may be of type ‘emergency request’ or ‘disaster roaming’ as per TS 23.501. As another alternative, device A 20 or another device of the first responder network may need to connect to a Public Safety Answering Point (PSAP) and may provide it with SUCI of device UE 24 and/or information about the home PLMN of device UE 24 and/or the emergency credentials. Such PSAP may have emergency access to the respective home PLMN of device UE 24 (e.g. through the NEF), and hence may be able to request the home PLMN of device UE 24 to de-conceal the device identity and/or allow the device UE 24 to register to the first responder network and return this response to the first responder network. The PSAP may also request the home PLMN to set up a secure connection between the home PLMN and the first responder network, directly (e.g. a TCP/IP connection over the Internet) or via the PSAP. Through the secure channel the home PLMN may provide information about a signal or message or credential that the first responder can use in its invitation, trigger or request to device UE 24 to enable connection to first responder network. The home PLMN may (e.g. upon request of the first responder network to allow device UE 24 to connect to the first responder network) update the steering of roaming information or the prioritized list of non-public networks of device UE 24 by adding an identity of the first responder network (that may be provided by the first responder network through the secure connection) and/or may update other policy information of device UE 24, to enable it to connect to device UE 24. It may also de-register device UE 24.

In order to facilitate easy and automatic registration of wireless communication devices in an MCI area of the MCI event, e.g. to enable automated counting, tracking or identification of casualties, the devices B 22 may receive information about a target geographical area or volume (e.g. from a network controller device (device A) 20) and get configured to allow wireless communication devices within that target geographical area to automatically get registered via a respective device B 22 to the core network operated by device A 20. This can be achieved by an invitation or connection trigger/request which may be a signal or message indicative of an emergency situation transmitted by an access device of the first responder network 200. In an example, this could be a public warning system (PWS) signal, or SMS/IMS message, or a system information block (SIB) or Radio Resource Control (RRC) message or Non-Access Stratum (NAS) message or preamble containing a flag or an information element. In an example, the first responder network may broadcast its support for disaster roaming (as per TS 23.501), and may include flag/attribute (e.g. boolean “emergency use request”) with a value to indicate that it requests/invites devices to connect and/or may include a flag/attribute with an identity of a particular device UE 24 (e.g. SUCI) to register to the first responder network. The signal/message or one of its information elements may be signed or may contain some security credentials that may indicate an emergency situation or MCI event (e.g. digital certificate signed by a first responder organization or the government). Sending an invitation or connection trigger/request may be achieved by sending an emergency indication (and/or emergency credentials) during setting up a call to device UE 24, by calling a special number related to the device UE 24's phone's phone number or by sending a USIM application/service commands or (secret) dial codes to device UE 24, or by sending a broadcast messages with a predefined payload (e.g. via multicast/broadcast service framework) or SMS with special code.

Instead of or in addition to the invitation or connection trigger/request to connect to a wireless communication network offered by devices B 22 and/or device A 20, the invitation or connection trigger/request may include an instruction start communicating via sidelink or to set up a sidelink connection to another wireless communication device (e.g. a shared patient monitor that collects data from a set of victims), or trigger a handover from one access device to another access device or from one wireless communication network to another wireless communication network.

In addition, the invitation or connection trigger/request may contain a minimum/maximum distance (e.g. to the access device B 22 or to a specific coordinate or reference point/device (e.g. Position Reference Unit as described in R2-2106920)) or a set of coordinates (absolute (e.g. geographical coordinates) or relative to a reference point/device (e.g. Position Reference Unit as described in R2-2106920)) indicating the target area/volume for which devices are invited/triggered to connect or a tracking area identifier and/or tracking area dimensions (e.g. set of coordinates) or a forbidden area identifier and/or forbidden area dimensions (e.g. set of coordinates). Instead or in addition to the invitation or connection trigger/request, information about one or more target areas in which devices are allowed/disallowed to connect may be securely provisioned (e.g. by the PCF) to device UE 24 beforehand, e.g. a set of coordinates indicating a tracking area dimension and a related tracking identifier, after which device UE 24 can upon detecting access device B 22 (e.g. upon receiving a connection trigger/request) estimate its location and enforce whether or not is allowed/disallowed to connect to access device B 22. Devices that are outside the designated target area/volume do not need to respond if their position is not within the target area/volume, or alternatively device B 22 (possibly together with device A 20) may filter out (e.g. decide which devices may register to device B 22 or not) the devices that have or do not have a position within the target area/volume. Additionally or alternatively, device B 22 may allow devices (e.g. device UE 24) to register to it, and allow the devices to initiate registration to the first responder network (e.g. by forwarding the messages received from the devices to device A 20), upon which the first responder network (e.g. by the AMF/AUSF of the core network of the first responder network that may be operated by device A 20) may filter out (e.g. decide which devices may register to the first responder network 200 or not) the devices that have or do not have a position within the target area/volume. To this end, device B 22 or device A 20 may contact a location service/database to fetch location information of the respective device(s) UE 24 or may use location/location measurement (e.g. timing of Sounding Reference Signals or Position Reference Signals) information provided by the respective device(s) UE 24 or devices B 22. Device A or device B may also obtain a location of the respective device(s) UE 24 by connecting to a Public Safety Answering Point which may have or may be able to contact a location service that may provide the latest information about the location of the respective device(s).

In an embodiment which may be combined with any other embodiment or implemented independently, the target geographical area of the base station or access devices (device B) 22 for triggering/request invitation and/or based on which the device B 22 and/or device A 20 may filter out devices that have or do not have a position within the target area/volume (and hence are allowed/disallowed to register to the first responder network). The target geographical area may be smaller than the coverage area of a single base station or access device. That is, the devices B 22 may be configured to receive information about the dimensions “(e.g. a set of coordinates (absolute (e.g. geographical coordinates) or relative to a reference point/device (e.g. Position Reference Unit as described in R2-2106920)) and/or a (set of) minimum/maximum distance(s) e.g. to one or more access device B 22 or to one or more specific coordinates or to one or more reference points/devices (e.g. Position Reference Unit as described in R2-2106920)) of a target geographical area which may be a subregion of the coverage area of one or more devices B 22 and/or to invite or trigger/request one or more of the devices UE 24 in its coverage area to register via a respective device B 22 to the core network operated by the device A 20. The device B 22 may fetch or calculate a distance or position (possibly in cooperation with other devices and/or location service in the core network) from a set of devices within the coverage area of the device B 22 by transmitting and receiving respective location signals (e.g. position reference signals, round-trip time measurement signals). Alternatively, the device B 22 or device A 20 may contact a location service or database (which may also be provided by another network service/server, such as a Network Data Analytics Function (NWDAF), that may provide data about devices (e.g. capabilities, types, identities) and/or device location in a certain area and/or last/previously known location of a device, e.g based on earlier data collection and measurements, e.g. operated by the device A 20, or by a PLMN to which device UE 24 is connected to, to fetch the set of devices inside the target area/volume, and based on this information may send an invitation or connection trigger/request only to the respective set of devices. To this end, the invitation or connection trigger/request may include device identity information of target devices, or the device B 22 (possibly together with the device A 20) or device A 20 may filter out the devices that match or do not match the respective identities. Instead of sending an invitation or connection trigger/request, device A 20 or B 22 may allow device UE 24 to register to the network, and then during or after registration estimate the position of a device UE 24 by exchanging position estimation signals or by exchanging location information (e.g. between device UE 24 and devices A 20 or B 22, or by device UE 24 providing location/location measurement (e.g. timing of Sounding Reference Signals or Position Reference Signals) during the registration procedure), after which the network may discontinue connection setup procedure or deregister/disconnect the UE if the estimated location is not within the configured target area. Alternatively, after initial registration and/or PDU session setup of device UE 24, device A 20 or B 22 may contact a location service or database, e.g. operated by the device A 20 and/or first responder network 200, or by a PLMN to which device UE 24 is connected to “(and to which device UE 24 may send its position estimation signal measurement or its location information and/or through which the position of device UE 24 can be determined)”, to fetch the estimated position of device UE 24. It may require authorization from device UE 24's home network operator to be able to determine the position of device UE 24 and/or get access to the location services and hence may require device A 20 or device B 22 to provide emergency credentials/certificate as mentioned earlier. Instead of contacting a location service or location database (possibly operated by device UE 24's home network operator), device A 20 or B 22 may also send a message to the location service or location database with target area information and possibly including an identifier received from device UE 24 (e.g. a Subscription Concealed Identifier (SUCI)), after which the location service or location database will respond with a message with information about whether UE is currently located in the respective target area or not, but not revealing any additional identity information about device UE 24 (such as International mobile subscriber identity (IMSI) or Subscription Permanent Identifier (SUPI)) to maintain privacy of device UE 24 towards the network operated by device A 20.

In another alternative, the first responder network may have a roaming agreement with the device UE 24's home network, and e.g. provides home routed roaming to the device UE 24's home network as per TS 23.501. In this case, the device UE 24 may register to its home network (via the roaming connection offered by the first responder network) and hence may use the location service of that network. The first responder network may provide information about the target area to the device UE 24's home network, e.g. by the AMF adding such target area information to the home routed registration request forwarded from device UE 24 to the device UE 24's home network, or e.g. by providing this information through NEF between the first responder network and the device UE 24's home network. The home network of the device UE 24 may decide based on the provided target are information (e.g. by checking with its location service if device UE 24's location is within the target area or not) if the device UE 24 is allowed to register to the first responder network or not. If not allowed, it may discontinue the registration procedure or de-register the device.

Additionally or alternatively, the device B 22 may have multiple antennas and send its synchronization signal or invitation or connection trigger/request only in certain beams or certain Synchronization Signal Blocks (SSBs). The signal/message may also be broadcast on all beams in all directions, but may contain e.g. an index to a certain SSB to allow the devices UE 24 to respond or not respond based on that index. Alternatively, device UE 24 may send the SSB/beam index and/or other beamforming related information (e.g. channel state information, signal direction or other measurements) to device B 22, which may use this for deciding whether device UE 22 is situated in a particular coverage area corresponding to a SSB index. Based on the configured target area information (e.g. as received through the NEF), one or more beams may be adjusted to become narrower (e.g. by applying different OFDM encoding to decrease the spatial diversity, adjusting antenna array configuration, applying different transmit power pattern for antenna area, reposition antennas, move panels/reflective surfaces, etc.) in order to target a smaller coverage area. Additionally, device A 20 or device B 22 may be connected to other access devices/base stations, whereby the devices exchange messages to provide a synchronized set of beams from multiple base stations (e.g. by using Coordinated Multi-Point transmission/reception (CoMP)) to have very good signal in the configured target area (so good that the beams may each use less signal strength, so individual beams are less strong in other coverage areas making the service to the UEs outside the configured target area much worse or even unusable). The area covered by a beam is likely circular or spherical in nature. The target areas allowed to be configured (e.g. through the NEF) may be restricted to such shapes. In order to apply beamforming for other configured shapes, device A 20 or device B 22 may perform some shape matching and use multiple overlapping beams (from one or more access devices) to cover as much of the configured target area as possible and have as little coverage outside the configured target area, e.g. by algorithmically determine various combinations of overlapping beams and/or beam configurations, and for each combination/configuration to measure the expected percentage of overlap with the configured target area and/or an estimation of the areas outside the target area that are also covered by the beams (given various beam configurations), and comparing these percentages and/or estimates to determine the best configuration/constellation of overlapping beams.

Note that the invitation or connection trigger/request could include information about an (additional) emergency number to enable the device UE 24 to set up an (unauthenticated) emergency call upon receiving the invitation or connection trigger/request to the designated emergency number.

The invitation or connection trigger/request may be restricted or targeted to certain groups of devices UE 24 (e.g., those operated by first responders) and/or to specific types of devices UE 24 (e.g., such with specific capabilities (e.g., sidelink communication or access to Global Positioning System (GPS))).

Additionally, if the communication with the home PLMN could not be established within a stipulated amount of time during an MCI event (e.g. due to network failure of home network), the device A 20 may provision the device UE 24 with the network credentials (e.g. SIM profile) of the first responder network 200 via a universal subscriber identity module (SIM) provisioning server (e.g. as specified under root discovery service specified in GSMA—SGP.22 RSP Technical Specification) based on the device identity (e.g. permanent equipment identifier (PEI) or international mobile equipment identity (IMEI) obtained directly from the device UE 24 through a pre-installed user application via secure out-of-band communication such as Wi-Fi) and/or non-concealed subscriber identity (e.g. globally unique temporary identity (GUTI)) obtained from the device UE 24 without security context (e.g. RRC setup of 5G network as specified in 3GPP TS 33.501 Security architecture and procedures for 5G system) in an emergency scenario (e.g. during set up of an emergency connection between first responder network 200 and device UE 24). Alternatively, it may download/provision security credentials (e.g. TLS certificate) over a control plane connection (e.g. through NAS/RRC message) or a Restricted Local Operator Services (RLOS) user plane connection with device UE 24, or via a sidelink connection between a device connected to the first responder network (e.g. a UE carried by a first responder) and device UE 24 (e.g. by the first responder UE providing a public key of the first responder network through discovery messages or other sidelink messages, and/or by the first responder UE connecting via sidelink/PC5 to a ProSe application/service offered by device UE 24 for such purposes (e.g. using PC5 direct communication as specified in TS 23.304 between the first responder UE and device UE 24 for that particular application/service (e.g. a ProSe configuration service or ProSe emergency service)), and/or by the first responder UE providing access as a UE-to-Network relay to the device UE 24 which may initiate setting up a connection (e.g. an emergency connection) via the UE-to-Network relay to the first responder network, after which it may provided with (additional) security credentials and possibly also policy information to allow device UE 24 to register and make use of all the services of the first responder network.

In an embodiment which may be combined with any other embodiment or implemented independently, the first responder network may be enabled to override location privacy settings (e.g. set the privacy override indicator POI as specified in 3GPP TS 23.273 5G System (5GS) Location Services (LCS)) of the device UE 24, if the device B 22 of the first responder network 200 can prove that it is allowed to do so (e.g. by representing a PLMN operator class as specified in 3GPP TS 23.271 Functional stage 2 description of Location Services (LCS)) to the device UE 24 or the home network of the device UE 24. As an example, a device UE 24 may have a special permission set for such situations to not allow even government in all cases to have access. The device UE 24 may have stored a permission for the device or for an service/application on the device e.g. by setting an Android permission (e.g. (a not yet existing) android.permission.emergency-location or android.permission.location-override) to be enabled (e.g. which may have been enabled/approved when installing/configuring the device or a service/application, or which may have been explicitly set by the user of the device). Such permission may be linked to a password, key or other credential that may need to be provided to the device to confirm/enable/allow such permission. The user of device UE 24 may also have agreed beforehand to provide special permission by storing the consent to such special permission in the Unified Data Manager (UDM), Unified Data Repository (UDR), Home Subscriber Server (HSS) of the device UE 24's Home PLMN, which may be verified by the first responder by connecting to the respective Unified Data Manager (UDM), Unified Data Repository (UDR), Home Subscriber Server (HSS), e.g. through an NEF, or indirectly through a Public Safety Answering Point (PSAP), which may have access to the respective permission data or may have the ability to override the respective permission. In such scenario, a user or his/her friends/family (which may have been added to the information in the subscriber database (HSS), or which may have been listed as an emergency contact on the respective mobile phone's SIM card, non-volatile storage, or wearable connected to the mobile phone) may receive a notification to “unlock” the device and override location privacy indicator settings of the device or override the security lock on the device UE 24 or SIM card in order to accept the incoming invitation or connection trigger/request or incoming SIM profile or authorize these actions to be taken on behalf of the casualty. Alternatively, the device A 20 of the first responder network 200, can provision a new location service profile (e.g. as specified in 3GPPTS 23.273 5G System (5GS) Location Services (LCS)) when establishing the network connection with one or more access devices B 22 or devices UE 24 in an MCI area.

As another option, a first responder may be allowed to unlock the device UE 24 (e.g., based on a special authorization vested in the wireless communication device of a first responder by the network controller device A 20), after which his/her identity (e.g. subscriber concealed identity SUCI of the wireless communication device of the first responder) is recorded at the device UE 24 or the device A 20 to check later if this has been a legitimate action. Alternatively, device UE 24 of the first responder can be authorized to provision (e.g. by the device 20) a new location service profile to the one or more devices UE 24 or override location privacy settings to enable ranging between the first responder device and the one or more device UE 24 or enable location sharing services (e.g. by setting location privacy indicator LPI to allowed for a stipulated amount of time) of the device UE 24 (e.g. via NEF as specified by 3GPP TS 23.273 5G System (5GS) Location Services (LCS) or via secure out-of-band communication such as NFC).

Furthermore, invitations or connection triggers/requests may be restricted to devices UE 24 (e.g., first responders) that have access to a particular network slice (e.g., available network resource), e.g., by including a particular slice identifier (S-NSSAI) as part of an invitation signal/message or connection trigger/request. Also, devices UE 24 of victims may be assigned to different network slices, e.g., depending on the severity of their injuries. Groups of devices UE 24 may be invited or triggered/requested to connect e.g. based on a special information element in a signaling information or a special RRC message from the device B 22. Thus, multiple network slices may be deployed that deliver same features for different groups of devices UE 24. Inviting or triggering/requesting a device UE 24 to connect to a certain network slice could also be achieved e.g. by adding the network slice to an allowed network slice selection assistance information (NSSAI) list for a particular device UE 24 in a group of devices UE 24 and/or devices UE 24 in a specific geographical area and/or devices UE 24 with an explicit invite or connection trigger/request. In an example, a network slice may be restricted to a certain geographical area smaller than the coverage area or tracking area of a single device B 22. Additionally or alternatively, device UE 24 may be configured with steering of roaming information/list of preferred non-public networks that next to PLMN/NPN information also includes information about which (preferred) network slice/NSSAI to connect to. Hence, in case of first responder network 200, device UE 24 may be provisioned with the identity of the first responder network and the (preferred) network slice/NSSAI to connect to upon registration. Based on this information, whenever device UE 24 registers to first responder network 200, it will automatically request the configured (preferred) network slice/NSSAI upon registering to the first responder network.

A network controller device A 20, via the device B 22 needs to securely yet authoritatively invite or trigger/request the device UE 24 to connect to a first responder network 200 in an MCI area. In addition to an explicit invitation or connection trigger/request message being transmitted from device B 22 (i.e. sent to device UE 24 without prior corroboration of home PLMN), the invitation or connection trigger/request may also be implicit (i.e. sent out to device UE 24 with prior corroboration of home PLMN), whereby the following scenarios could be distinguished:

a) A device UE 24 may be located in a coverage area of an existing network infrastructure, connected to a PLMN with which the first responder network 200 has a roaming agreement. In this scenario, the first responder network 200 could have been given a higher priority in the steering of roaming information or prioritized list of Non-Public Networks and hence the invitation or connection trigger/request is an implicit one and the concerned device UE 24 will connect automatically to such network as soon as it discovers the respective first responder network 200. In this case, device B 22 (possibly in cooperation with device B 20) may filter out the devices that are outside the designated target area by determining the distance/position (e.g. through triangulation/trilateration of different signals received by one or more access devices) or by comparing the location information (e.g. GPS coordinates) for such device UE 24 or through one of the other methods as mentioned before. Estimating the position of a device UE 24 may be done before the UE has completed the registration procedure (which may include authentication) and/or PDU session setup procedure, for example by using pre-registration messages (e.g. position estimation signals) to perform location estimation (e.g. TDOA measurements, signal strength information, SSB index/pattern, e-CID time difference values), or by sending (encrypted) position information (which may include position estimation signal measurement (e.g. time of arrival of a position reference signal)) by the UE to the network (e.g. encrypted using a public key of the network, e.g. based on the same Home Network Public Key or similar/derived key that is used for encrypting the SUCI (as per TS 33.501), or a different public key exposed e.g. through the System Information (SI) provided by an access device or emergency credentials). Estimating the position of a device UE 24 may also be done after the UE has (partially) completed the registration procedure and/or PDU session setup procedure by exchanging position estimation signals or by exchanging location information (e.g. directly from device UE 10, or by fetching location information of device UE 24 from a location service or database, e.g. operated by the device A 20 and/or by the first responder network, or by a PLMN to which device UE 24 is connected to, and to which device UE 24 may send its position estimation signal measurement or its location information and/or through which the position of device UE 24 can be determined), after which the network may discontinue connection setup procedure or deregister/disconnect the UE if the estimated location is not within the configured target area. In a particular example, device UE 24 may use home routed roaming via the first responder network 200 to device UE 24's home network, and hence may register to its home network and hence use the location service of the device UE 24's home network. The first responder network may provide information about the target area to the device UE 24's home network, e.g. by the AMF adding such target area information to the home routed registration request forwarded from device UE 24 to the device UE 24's home network, or e.g. by providing this information through NEF between the first responder network and the device UE 24's home network. The home network of the device UE 24 may decide based on the provided target are information (e.g. by checking with its location service if device UE 24's location is within the target area or not) if the device UE 24 is allowed to register to the first responder network or not. If not allowed, it may discontinue the registration procedure or de-register the device.

In an embodiment which may be combined with any other embodiment or implemented independently, the above mentioned mechanism to estimate the position of device UE 24 [i.e. by estimating the position of a device UE 24 before the UE has completed the registration procedure and/or PDU session setup procedure, for example by using pre-registration messages (e.g. position estimation signals) to perform location estimation (e.g. TDOA measurements, signal strength information, SSB index/pattern, e-CID time difference values), or by sending (encrypted) position information by the UE to the network (e.g. encrypted using a public key of the network, or emergency credentials), or by estimating the position of a device UE 24 after the UE has (partially) completed the registration procedure and/or PDU session setup procedure by exchanging position estimation signals or by exchanging location information], may be applied for geofencing purposes, e.g. during registration of a UE to the network. Such geofencing may enable an access device, location service or other network entity based on e.g. information about an area (e.g. set of coordinates/distances) and information about an estimated position of a UE to verify/ensure that a UE does not attempt to register from a non-allowed/forbidden area and in case it does attempt to register from a non-allowed/forbidden area to e.g. reject the registration or de-register the UE, or to verify/ensure that a UE registers to an access device in the correct country/area (e.g. to ensure that a UE registers to a satellite from a designated country and/or to a PLMN operating within a specific country) and if the UE access the network from an incorrect country/area to e.g. reject the registration or de-register the UE if the UE access the network from an incorrect country, or to verify/ensure is allowed to use a certain licensed frequency band and if not allowed to use that frequency band to send a message to the UE and/or the access device to which it is connected with information/trigger to switch to another frequency band, or to verify/ensure that a UE registers to the correct network covering a specific area/location and otherwise reject the connection attempt and/or force the UE to roam/register to another network covering that specific area/location (e.g. by providing the identity of the another network in a rejection/error/(re-)configuration message), or to verify/ensure that a public warning signal is only sent to a UE.

b) A device UE 24 may be located in a coverage area of an existing network infrastructure, connected to a PLMN with which the first responder network 200 has no roaming agreement (e.g., because the new first responder network 200 always starts as a fresh network). In this scenario, a network controller device A 20 of the first responder network 200 may capture the concealed device identity (e.g., SUCI) or globally unique temporary identifier (e.g. GUTI) of the device UE 24 via device B 22. An initial and temporary radio resource allocation (e.g., PDCCH in 5G network) with no security context (e.g., RRC setup phase in 5G network) can be established between device B 22 and device UE 24 (e.g., as specified by 3GPP TS 38.331 Radio Resource Control (RRC) protocol specification) to allow exchange of these temporary network identifiers without security context. A function in network controller device A 20 (e.g. access and mobility function AMF of 5G) can be used to identify the home PLMN of the device UE 24 by decoding the temporary identifiers (e.g. obtain MCC and MNC information from SUCI) and establish a temporary roaming agreement for a duration of the MCI event at a specific location of the MCI event. A temporary roaming agreement may be established if the first responder network 200 can prove its integrity based on a hardware root of trust established with the network operator recognized trusted platforms (e.g., GSMA root of trust) to the home PLMN or if the first responder network 200 can prove (e.g. through digital certificate signed by a first responder agency or the government) that it involves an emergency situation. The communication between the first responder network 200 and remote provisioning platform may only be established if the first responder network 200 can prove its integrity with a root of trust established with the network operator recognized trusted platforms (e.g., GSMA root of trust and security domain, e.g., as described in GSMA SGP.22—RSP technical specification).

c) A device UE 24 may not be provisioned with any network credentials (e.g., a (new) mobile phone without a subscriber identity module (SIM) profile of a network). In this scenario, the device UE 24 may be provisioned with network credentials of the first responder network 200 via a universal provisioning server (e.g. as specified under root discovery service specified in GSMA-SGP.22 RSP Technical Specification) using out-of-band (e.g. Wi-Fi) communication link established between the device B 22 and the device UE 24 either directly or via another device UE 24 (e.g. a first responder UE connected to the device UE 24 via sidelink).

Furthermore, in all the above scenarios or as an independent embodiment, an implicit invitation or connection trigger/request can be sent for devices UE 24 in a target geographical area of the MCI area (e.g. by the device 20 after these devices are discovered (e.g. by receiving some signals from these devices) by device UE 22), e.g. by contacting PLMNs that are active in the given MCI area. In such a case, a lawfully regulated device B 22 of a first responder network 200 can scan the PLMNs in the MCI area and may request each of these PLMNs (for permission) to trigger a control plane steering of roaming (e.g., as specified by GSMA IR.73 Steering of Roaming Implementation Guidelines, Version 5.0) or to trigger device UE 24 to move to Non-Public Network connection mode, e.g. by setting up a secure channel between first responder network 200 and the respective PLMN(s) using the methods described above. The home PLMNs of the devices UE 24 in the MCI area can temporarily set the first responder network 200 as a highest priority network for a stipulated duration after the occurrence of MCI event. Alternatively, a function in the network controller device A 20 of the first responder network 200 can communicatively couple with a function (e.g., access and mobility function AMF in 5G systems) in home PLMN networks in the target MCI area via secure and integrity protected channel (e.g. network exposure function NEF in 5G systems or one of the other methods described above to set up a secure channel between first responder network 200 and the respective PLMN(s)) to deliver the steering of roaming information (e.g. a list of PLMN identities including the identity of the first responder network and its priority) and/or a prioritized list of non-public networks to all the device UE 24 connected to the specific home PLMN.

Additionally, in all the above scenarios or as an independent embodiment, an explicit invitation or connection trigger/request (e.g., when there is no home and/or preferred PLMN available in the target geographical area of the MCI area) can be sent to a device UE 24 in a target geographical area of the MCI area by a device B 22. In such a case, a special and lawfully regulated broadcast information about the MCI event (e.g., system information block SIB as specified by 3GPP TS 38.331 Radio Resource Control (RRC) protocol specification), can be sent out as signaling message during the initial random access radio setup phase (e.g. signaling radio bearer 1 SRB1 and RRC setup of the 5G system) or as part of the information (e.g. System Information) broadcasted by the device B 22 of the first responder network 200. Such signalling message (e.g. broadcasted system information message) or a payload/information element of such signalling message may be securely signed/encrypted (e.g. using a mechanism as described in TR 33.809), whereby a key may be used for emergency/MCI events (e.g. a pre-shared key that is pre-configured in device UEs 24) and/or by using a key that may be provided e.g. using a certificate that is digitally signed by a first responder organization or the government, or by using a key that is derived from one of such keys/credentials). The signalling message may contain an identifier of the key that was used (in case multiple keys exist for similar purpose (e.g. for emergency situations) and may contain information about nonces/salts used for deriving the credentials to verify/decrypt the signed signalling message), such that the device UE 24 is able to decrypt the signalling message and/or verify that the signalling message is genuine. Alternatively, the signalling message may include a specific string (e.g. as part of a human readable name or part of an identifier of the network or cell) that can be recognized/pre-configured in device UE 24 to denote a first responder network, emergency network or another network it can/should connect to in emergency situations, in a certain geographical area, or e.g. when no other known network is available, and/or the signalling message may include a public key (e.g. as part of a digitally signed certificate) and/or an identifier of a key (e.g. a pre-shared (public) key) and/or an address (e.g. URL) from which the key material can be obtained, such that the device UE 24 may use such key (e.g. after fetching the key material from its storage or the given address) during authentication with the network, such that the network can prove to the device that it possesses the matching/private key. In case of a digitally signed certificate the device UE 24 may verify if it is signed by a trusted certificate authority by checking if it corresponds/links to a trusted root certificate stored/pre-configured in the device UE 24.

Alternatively or additionally, the device UE 24 may contact a server (e.g. an authentication server operated by its home PLMN or a certificate authority or the device manufacturer or other trusted organization), for example through a data connection via the home PLMN it is connected to, or via a Wi-Fi network it is connected to (that may be directly connected to the internet, or via which device UE 24 may connect to a Non-3GPP Interworking Function (N3IWF) in order to connect to a data network of a mobile operator network), or via an emergency/RLOS connection (e.g. through the first responder network). Upon connecting to such (authentication) server, the device UE 24 may request authentication of the respective network (e.g. from which it has received the signalling message) and/or obtain authorization to access the respective network, and/or request verification of the public key/certificate received from the respective network (e.g. to verify if the certificate is still valid and has not been revoked) and/or verify if the respective network can be trusted (e.g. is not part of a blacklist), and/or request decryption of an encrypted signalling message or encrypted payload within a signalling message. Contacting such authentication server may include sending a message that may include a copy of the signalling message or a subset of its contents (such as the public key), an identity of the network/cell from which it received a signalling message, and/or an identity of the device UE 24 and/or credentials of the device UE 24. In an alternative, device UE 24 may after receiving a signalling message (e.g. invitation/request/system information block) from the first responder network may use its current connection to its home network (e.g. via a nearby base station) or may set up a new connection to its home network, to send a message (e.g. RRC or NAS message) to the home network with a copy/subset of the information received from the first responder network (e.g. through the signalling message), and request and/or be granted permission by the home network to connect to the first responder network. The home network may send a message to the device UE 24 to grant such request/permission, and/or may update the steering of roaming information and/or list of prioritzed list of non-public networks and/or policy information of device UE 24 by adding an identity of the first responder network (e.g. to the steering of roaming information or prioritized list of non-public networks), to enable device UE 24 to connect to the first responder network. It may also de-register device UE 24.

The signalling message as described above may also be received by device UE 24 indirectly from a first responder network through sidelink (e.g. via a ProSe UE-to-Network Relay that may provide signalling information such as PLMN identity information in ProSe discovery information or during connection setup as per TS 23.304 and which may further include information about the emergency situation (e.g. through a Relay Service Code specific for emergency situations). The signalling message may also be received from the home network to which device UE 24 may be connected or received from an access device operated by the home network, whereby the signalling message may contain message/information to request and/or authorize device UE 24 to connect to first responder network instead of (e.g. through a roaming trigger or e.g. by sending a message to device UE 24 to (temporarily) override the steering of roaming/prioritized list of non-public networks configuration). The home network may also trigger a tracking area update and/or configure device UE (temporarily) with a non-allowed area/forbidden area for an area (partially) covering the MCI area and/or configure an access device to (temporarily) add device UE 24 to a non-allowed area/forbidden area, in order to trigger device UE 24 to connect to the first responder network rather than the device UE's home network. To this end, the first responder network may provide information about the target geographical area (e.g MCI area) to the home network of device UE 24. This also allows the home network of device UE 24 e.g. to only send a signalling message to devices UE 24 that are currently present in the target geographical area. This signal or message may be sent in a dedicated frequency band to designate that it originates from a first responder network 200 and/or designates an emergency situation. In addition, the signal may be sent on multiple different frequencies. To this end, the devices B 22 may receive information about the network configuration to be able to setup a communication channel with devices UE 24 from the network controller device 20. The network configuration information may include information to configure and/or can be used to authorize the access device to invite or trigger/request devices UE 24 to connect to a specific slice/frequency of the network in the MCI area. The network configuration information may contain e.g. an authorization for an access device to invite or trigger/request wireless communication devices or additional access devices in the area to connect to the core network, network/slice specific settings (such as band/frequency, allowed devices, services offered, Restricted Local Operator Services (RLOS), steering of roaming/prioritized list of non-public networks, emergency/non-emergency slice indication), credentials (e.g. private key) needed to authorize a device UE 24 of a first responder. The operating band/frequency that will be provided in the network configuration information may be a special emergency band for MCI events or first responder networks. It may also be one or more common frequency bands supported by many UEs, and/or well known operators in the area. In order to determine if the first responder network in the MCI area is allowed to transmit in a certain frequency, it may first need to scan the area for existing PLMNs operating in the area, identify their MCC/MNC code, identify the nearest base station, measure their signal strength, and may connect to those PLMNs to request permission to send invitation or connection trigger/request signal in one or more frequency bands operated by the PLMN. If the nearest base station is very far away and/or certain PLMN is not active in the area, or a certain band is not measured of being in use, e.g. because the base stations in the area have been destroyed, or the signal is very faint, the network controller may provide respective frequencies as part of the network configuration information, and allow/authorize the access devices B 22 to use those frequency bands to send the invitation or connection trigger/request signal. It is also possible that the invitation to device UE 24 may be transmitted via an access device B 22 (e.g. Wi-Fi access point, through an information element in a Wi-Fi beacon or Probe Response message or e.g. a paging message from a Non-3GPP Interworking Function to which device UE 24 may be connect via the Wi-Fi access point) that is different from the access device B 22 (e.g. cellular base station) through which the device UE 24 will connect to the first responder network.

Furthermore, invitations may be restricted or directed to a certain group of victims and their corresponding devices UE 24, which are grouped based on the characteristics of the victim such as including but not limited to movement, position, and severity of injury. To this end a location management service or other position estimation function (e.g. in the device A 20 or device B 22) may be able to detect movement of UEs based on the observation of the position of a set of devices UE 24 in a MCI area for a certain period of time. For example, a victim with severe injury to the legs might not be moving around the MCI area, which would mean that the victim's device UE 24 is non-moving for a prolonged period of time. On the other hand, a victim with no injuries might be walking around in the MCI area, which would mean that the victim's device UE 24 is moving. The device B 22 of the first responder network may scan the area to identify such characteristics of the device UE 24 in the MCI area and group them based on derived characteristics of the victims, e.g. moving group and non-moving group of devices UE. In general, a non-moving group of victims might need prioritized triaging as they are considered severely injured. Additionally, before assigning a device UE 24 to such cluster/group, device A 20 or device B 22 may exclude first responder devices from the cluster/group (e.g. by distinguish first responder devices from other devices based on their registration or capabilities), and may exclude devices belonging to other clusters/groups (e.g. cluster of people grouped areas indicating e.g. victims in a certain triage area, or bystanders).

Based on this clustering, Device B 22 may initially send the invitation or connection trigger/request only non-moving devices UE 24 in MCI area since it is highly probable that victims of the corresponding non-moving devices UE 24 are severely injured and require immediate triaging.

More generally, several devices UE 24 may be grouped into a cluster based on a triage status of a tarp, a spatial location of a device UE 24 and other properties (such as including but not limited to dimensions in horizontal and vertical planes (e.g. the size of an area or tarp), number of associated devices, position accuracy, location of the cluster and the device(s) in the cluster, distance from the centre of the cluster to a device UE 24) of the devices in a cluster and/or the device UE in the center of a cluster. A cluster is typically denoted by a set/group of devices having a set of common characteristics (e.g. communication/device/user characteristics) and/or that are located in a certain delimited area or are located within a certain maximum distance from each other.

The characteristics for recognizing/forming a cluster may also be a (set of) distinguishable feature(s) for a set of devices, that is not available/applicable for other devices. For example, the devices may be clustered depending on whether they are moving around (which may indicate that the injuries of a casualty carrying the device is less severe) or not moving for a certain period of time (which may indicate that the injuries of a casualty carrying the device are more severe).

Alternatively, the device A 20 of the first responder network may recognize a center of the cluster/group through its communication characteristics (e.g. high bandwidth, low latency, QoS requirements). Additionally, the device A 20 may detect/infer devices to belong to a certain cluster/group if all devices have similar communication characteristics (e.g. same QoS, similar traffic pattern, operating in the same bands or same slices or closed access groups, support the same capabilities, or are all connected to each other via D2D/sidelink communication or are operating in similar (application-controlled) group/multicast communication.

Such clusters/groups of devices can be recognized/formed at the device A based e.g. on a triage application or information provided/collected by network analytics function (such as NWDAF), or by the device A either via device B or via a 3rd party positioning server depending on the ranging distance between multiple UE and clusters/groups or based on the communication characteristics of the devices in a specific cluster/group.

Device A may send information about a cluster/group of wireless communication devices to device B which may invite/trigger/request each of these devices in such cluster/group to join the wireless communication network.

To this end Device B may operate or connect to a first apparatus for supporting establishment of a wireless communication network (200), wherein the apparatus is configured to:
connect to a network controller device A (20) of the wireless communication network (200) and provide wireless connectivity to wireless communication devices (24) within a target geographical area;
receive information about a cluster/group of wireless communication devices (24) (or at least a subset of the cluster/group of wireless communication devices for which the determined position falls within the target geographical area/coverage area), whereby the information may include (but is not limited to) device identifiers and/or positions and/or common characteristics of wireless communication devices within the cluster/group;
receive from the network controller device (20) information about the network configuration to setup a communication channel with wireless communication devices (24); and
   invite or trigger wireless communication devices (24) of the cluster/group of wireless communication devices to register or de-register via the communication channel or other communication channel to the core network operated by the network controller device (20).

Device A 20 (or another device in the first responder network) may include or connect to a second apparatus for determining a cluster/group of wireless communication devices in a wireless network (e.g. first responder network 200), wherein the apparatus may be configured to receive or learn at least one of resource usage data, position or distance measurement information, device characteristics, communication characteristics, measurement data, user characteristics of a plurality of wireless communication devices (e.g. devices UE 24); assign a minimum number of wireless communication devices for making the determination of a cluster/group of wireless communication devices; calculate at least one of:
distance between the wireless communication devices;
distance between the wireless communication devices and an anchor device (e.g. device B 22);
distance between the wireless communication devices and a target geographical area or the position of the wireless communication devices in relation to a target geographical area;
communication pattern information; and
overlap in communication characteristics, device characteristics and user characteristics;

determine a cluster/group of wireless communication devices based on at least one of:
the calculated distance between for at least the minimum number of wireless communication devices being between a minimum and maximum distance measurement threshold;
the calculated distance between for at least the minimum number of wireless communication devices and an anchor device being between a minimum and maximum distance measurement threshold;
the calculated distance between for at least the minimum number of wireless communication devices and a target geographical area being between a minimum and maximum distance measurement threshold;
communication pattern for at least the minimum number of wireless communication devices being the same, or whereby the time variability is between a minimum and maximum time variability threshold; and
the communication characteristics, device characteristics and user characteristics for at least the minimum number of wireless communication devices being the same for at least a minimum number of characteristics.

The above described apparatus for supporting establishment of a wireless network or the above apparatus for determining a cluster/group of mobile devices in a wireless network may be further configured to identify a mobile wireless device (e.g. device UE 24) in a cluster/group; monitor a position of the identified device within the cluster/group to detect a movement of the identified device between different clusters/groups and/or associate the cluster/group with the identified device, or monitor at least one communication characteristic of the identified device in the cluster/group to determine a change of an associated cluster/group of the identified device; and/or perform one or more of the following actions:
trigger de-registration of the identified device from the network or slice
trigger a handover to a different access device or to connect to a device over sidelink.
assign the device to a different cluster/group of devices.
send a different invitation message to the device
change the QoS or adapt the resource allocation for the device.
change the set of allowed slices for a device.
change a communication parameter in an access device
trigger sending of a message (e.g. through NEF, SMS) that may include a warning that a certain victim or wireless communication device has moved to a different tarp, or outside the area (e.g. to a hospital).
   These actions may be triggered if the identified device has moved beyond a configured threshold distance from the center of a cluster/group or distance from another device within the cluster/group and/or has moved below a configured threshold distance from the center or other device of another cluster/group. These actions may also be triggered if the current access device(s) (anchor nodes, e.g. devices B 22), in their current position, cannot achieve the QoS for the devices in a cluster/group or in a certain target geographic area Any of the above devices and first and second apparatuses and a set of wireless communication devices (e.g. devices UE 24) may form a system, wherein the wireless communication devices send at least one of resource usage data, position or distance measurement information, device characteristics, communication characteristics, measurement data, user characteristics to the second apparatus; the first apparatus receiving information about a cluster or group of wireless communication devices (24) and setup a communication channel with wireless communication devices (24), and invite or trigger wireless communication devices (24) of the cluster or group of wireless communication devices to register or de-register via the communication channel or other communication channel to the core network operated by the network controller device (20).

Upon registration, a unique identifier (e.g. 5G-GUTI) of the wireless communication device UE 24 received by the device B 22 of the first responder network 200, can be used to derive/obtain the subscriber information and the device identifier and authenticate the wireless communication device.

A robotic device or drone or vehicle or other mobile apparatus that acts as an access device may be configured to receive information from the device a 20 to be able to authenticate and/or identify itself as a first responder device and have the capability to run corresponding core network function(s) (e.g. AMF/MME, AUSF, UDM/HSS) locally, so that it could perform the task of providing network registration locally (e.g. for wireless communication devices in the coverage area of the access device operated by the mobile apparatus), in case it gets out of coverage and loses connection to the device A 20. This approach is similar to coupling an external device (from another emergency department) to the device A 20 to provide the authentication for the wireless communication devices instead of the device A 20 having to do that by itself The UDM/HSS operated by such device may only contain a (pre-registered) subset of subscribers that may be available in the UDM/HSS of the first responder network and/or a (pre-registered) subset of subscribers that are allowed to register to the first responder network (e.g. through a roaming connection to a UDM/HSS operated by a home PLMN of a wireless communication device).

As another or additional option, that can be added to any other embodiment or implemented independently, if a wireless communication device is not known or pre-registered by the unified data management function (UDM) or home subscriber server (HSS) of the first responder network 200 and not known or not available by the home networks with which the first responder network 200 has a roaming agreement, then the first responder network 200 may authenticate the device and derive its identity and subscriber information by contacting and redirecting the authentication request to an external device that has temporarily been coupled to the first responder network 200 at an MCI event and that operates a (copy of the) AUSF/UDM/HSS of another network (e.g. from a neighboring region's first responder department).

In an example, wireless communication devices carried by personnel from a different region (e.g. neighboring region fire brigade) could be considered as inbound roaming devices to the first responder network 200. Normally, a visiting network would be able to connect to the home network of that inbound roaming device to verify the subscription and other information of that inbound roaming device. In the case of an MCI event with a temporary non-public network, this may even be done if the backend infrastructure is down. One of the devices (e.g. an UE, a mobile base station/drone, or a specially dedicated device that may be carried by the personnel from a different region) could connect (i.e. wirelessly or by wireline) to the network controller and be coupled (e.g. through the SCEF/NEF, or through the SBA framework, with proper credentials) to the core network of the device A 20 of the first responder network 200, in order to (temporarily) take up the role to act as authenticator (e.g. an authentication server function (AUSF)) and subscription owner registry (e.g. UDM, HSS) for those inbound roaming devices. This device could have a duplicate version of those components from the home network and/or may contain a (pre-registered) subset of subscribers that may be available in the UDM/HSS of the respective home network (e.g. the network for the personnel from the different region).

In other words, device A 20 may incorporate or connect to an apparatus for supporting establishment of a wireless communication network (200), wherein the apparatus is configured:
to onboard an external device and/or connect to an external device over a local connection limited in range and provide a coupling to a core network of the wireless communication network (200) in order to allow the external device to act as authenticator and/or a subscription owner registry for a set of wireless communication devices (24).

To this end, the external device (which may be operated/owned by a different operator or different network) may operate an onboarding interface or protocol and/or allow setting up a connection to a network controller device A 20 over a local connection limited in range, and provide a coupling to another core network (in this case wireless communication network 200) to allow the external device to act as authenticator and/or subscription owner registry for a set of wireless communication devices (24)

Such external device and such network controller device A 20 incorporating or connected to an apparatus for supporting establishment of a wireless communication network may be used in a wireless communication system comprising one or more wireless communication devices (24), an access device (22) connected to a network controller device (20), and such external device, wherein the system is configured to provide device authentication of a wireless communication device (24) via a coupling between the network controller device (20) and the external device (which may be operated/owned by a different operator or different network).

This coupling may be temporary in nature, and all information related to registered devices (e.g. related to the AUSF/UDM/UDR) may be removed before decoupling, and certain security credentials may be refreshed before coupling to another network. Such coupling may be achieved by the external device connecting to the network operated by network controller device (20) by performing a mobile registration procedure via access device (22) (for which it can use EAP-AKA using SIM-based credentials), or by initiating an un-authenticated emergency connection to the network operated by network controller device (20), or by setting up a disaster roaming connection as per TS 23.501, or by setting up a connection to the Network Exposure Function (NEF) as per TS 23.501 of the network operated by network controller device (20), or by setting up an Service Based Interface (SBI) connection as per TS 33.501 (e.g. between the AMF of the network operated by network controller device 20 and the UDM/AUSF operated by the external device), and/or by providing an address of an AAA server to network controller device (20) which may configure its AUSF or Network Slice and SNPN Authentication and Authorization Function (NSSAAF) to use such external AAA server for authentication. In order to set up the coupling in a secure manner, the external device and network controller device 20 may perform a security handshake, e.g. using pre-shared/pre-configured credentials, or using emergency/disaster roaming credentials, or by providing/prove the possession of a special key or certificate (e.g. digitally signed by a certificate authority for emergency personnel or the government) during the coupling.

Furthermore, a first responder's device may be capable of supporting sidelink communication (e.g. ProSe D2D communication) and thus be able to set up an ad-hoc/mesh-type network. In such a situation it may make sense to have a set of devices belonging to first responders of a different specific regional facility or different first responder network 200 that would normally know each other and would be able to form an ad-hoc/mesh type network, to all take part in a distributed ledger, so that the devices in that ledger are able to prove that an incoming roaming device belongs to that same network/regional first responder facility.

Alternatively or additionally, the devices could each run a group application, whereby each device of a certain group may have the same core group key, that allows each of these devices to check if another device (i.e. the inbound roaming device for the first responder network 200) belongs to that same group by verifying if a temporary key, hash/nonce, authentication code, signature or other data is signed by a key derived from that group key. As a result, such a group of devices (i.e. with same group key or running same distributed ledger) could all be added to the first responder network 200 in one go, or alternative if one device of the group of devices (from a different regional first responder department/network) is properly authenticated, authorized and registered to a network, this device could act as an authenticator for other devices from the same group that are trying to register. This one single device that is registered may first need to perform some additional authentication, authorization and verification steps, e.g. by having a special key or certificate (e.g. digitally signed by a certificate authority for emergency personnel) during registration to prove that the wireless communication device belongs to a first responder.

Alternatively or additionally, the first responder network may perform an additional verification check based on the capabilities of the wireless communication device, e.g. by checking if the wireless communication device has certain specific capabilities (such as support for band 14 (Firstnet), high power operation, ProSe relay support) that are common for first responder devices, which would typically not be the case for normal consumer devices).

Alternatively, the first responder network 200 may contact a network-trusted third party portal which can securely process user data and device data (e.g. an identification server run by the government, GSMA or other organization).

The device and user information obtained from the user data resolution server may be used to register the device or to securely provision network credentials (e.g., subscriber identity module SIM profile) of the first responder network 200 via a remote provisioning platform (e.g., as described in GSMA SGP.21—RSP Architecture). The communication between the first responder network 200 and remote provisioning platform may only be established if the first responder network 200 can prove its integrity with a root of trust established with the network operator recognized trusted platforms (e.g., GSMA root of trust).

Moreover, the invitation or connection trigger/request may include information about a cause of emergency establishment in an invitation or connection trigger/request signal/message sent to the devices UE 24. The information may be provided in special or dedicated information element (IE) or in a preamble portion of the invitation or connection trigger/request message.

To achieve the required communication links, the devices B 22 may support single-hop relay links 22S and/or multi-hop relay links 22M to the devices UE 24 and/or base station relay links 22R among themselves.

The target geographical area could be focused on specific areas for triage (e.g., an area with most injured people, an area with less critical injuries and so on) or may be linked to a set of spatial formation requirements for identifying cluster formation (e.g., if multiple devices UE 24 are within a configurable radius around a designated relative coordinate, designated device UE 24, center of gravity, reference line, etc.). In an example, information about a potential target area (e.g. with a high concentration of potentially injured people) could be provided by one or more devices B 22 or by a separate device, e.g, via a network exposure function (NEF) and an application function (AF). In another example, a LiDAR camera is used to find heat signature of mobile phones and/or people, and in this way locate (clusters of) devices. Furthermore, triage specific areas of victims/casualties may be identified by triage tarps with different colors (e.g., each indicating a severity level of injuries). The position (and colors) of these tarps may be determined via a camera or other color detector operated in a drone or other access device (e.g. mobile base station) or a camera on top of an ambulance or fire truck or security camera available at the scene, or may be provided by a first responder to the network (e.g., via the NEF, or directly via a data connection with the SLAM function). As another or additional option that can be added to any other embodiment or implemented independently, the tarps could be provided with a wireless device by (possibly including a GPS module) that can register to the network to allow automatic determination of its position. In its capabilities or through matching the identity of the wireless device, the color and its size/shape/metrics/relative position of its corners can be determined. Alternatively, the tarps could be equipped with a location beacon (e.g., Bluetooth iBeacon) broadcasting its location, size, etc.

As another or additional option, that can be added to any other embodiment or implemented independently, the tarps may be digitally recreated such that the boundaries and dimensions of the tarp are drawn with a visible optical marker (e.g. using a laser projector) projected by a device B or any device that is capable and either connected or not connected to a first responder network in a MCI area. Depending on the number of casualties physically present in the digital tarp, the dimensions of the tarp can be increased or decreased either automatically by the device A 20 of the first responder network or via a 3^{rd} party service. Additionally, if the physical tarps are placed in such a way that the boundaries of the tarps are overlapping with each other, the effective ranging distance of the device UE 24, present in the center of the tarp can be reduced by a device A either directly or via device B or via a 3^{rd} party ranging service. A first responder operating from a remote location from the MCI area, can digitally recreate the MCI area with properties of including but not limited to tarps, devices, MCI environment, and characteristics such as including but not limited to locations, communication patterns, and movements of the first responders, victims and by-standers based on the information obtained by their respective devices UE 24 physically present in the MCI area. Such a remotely located first responder may also monitor the health condition of the victim through a powerful patient monitor connected either directly to a victim or shared among multiple victims depending on the severity of the injuries and the triage status of the victim.

Additionally, the first responders in the MCI area can be assisted with drone or robotic devices which can perform tasks such as including but not limited to carrying a victim and/or medicines and/or tools to a tarp or a designated location in and around the MCI area, way guiders or way finders for first responders, victims and by-standers, beacons for various functions including but not limited to cluster formation, victim identification and tracking, asset positioning, medicine transports. In an example, such a beacon drone can assist a first responder in moving a victim to a specific tarp based on the relative positioning between the different tarp location when there are multiple tarps in the vicinity.

Additionally, if emergency or restricted local operator services (RLOS) connections are mandated by a home PLMN of device UE 24 or by national regulations of mobile networks in the MCI area, an initial connection to the first responder network 200 with restricted service access can be established with the device UE 24 (e.g., as specified under provisions for continuity of service in 3GPP TS 22.011 Service accessibility). The device A 20 may be configured with a special privilege to update or override PLMN selection procedure to allow roaming of the device UE 24 in the first responder network 200 (e.g., as specified under steering of roaming information in 3GPP TS 22.011 Service accessibility) or similarly to update the prioritized list of preferred Non-Public Networks as per TS 23.501. The device UE 24 may now be connected to the first responder network 200 as a roaming device after successfully completing the roaming authentication procedure (e.g. as specified under service access authorization in 3GPP TS 33.501 Security architecture and procedures for 5G system). This may be based on a special cooperation between emergency or RLOS operators and mobile operators of the devices UE 24 or a national regulation to identify, authorize and allow the device A 20 of a first responder network 200 to establish a restricted service with a device UE 24 at a MCI location. This can be indicated (e.g. by including specific credentials or a key identifier of a pre-configured key, or by including a securely signed information element of the system information or a securely signed system information (e.g. as described in TR 33.809), whereby a key may be used for emergency/MCI events (e.g. a pre-shared key that is pre-configured in device UEs 24) and/or a key is used that may be provided e.g. using a certificate that is digitally signed by a first responder organization or the government), or a key that is derived from one of such keys/credentials in one of the network broadcast information blocks (e.g., system information block (SIB) as specified by 3GPP TS 38.331 Radio Resource Control (RRC) protocol specification) of the first responder network 200 while sending implicit and explicit invitations or connection trigger/request to the device UE 24 at a MCI location.

Once the wireless communication devices of the first responders and casualties in the MCI area are connected to the first responder network 200, the connection can easily be used to communicate relevant information between first responder personnel and (groups) of casualties, e.g. to keep them informed about what is happening, provide instruction what to do next or allowing a victim to state that he starts to feel worse. In order to do this, a first responder may be able (e.g. by using device 20, or access device 22, or a first responder UE that may be connected to the first responder network operated by/accessible through device 20 and/or access device 22) to remotely configure and control a device UE 24 of a victim or a group of devices UE 24 belonging to a certain class of victims (e.g. severely injured, mildly injured), such that audio/video/data calls are automatically answered from or initiated to a certain device UE 24 of a first responder, especially when the victim is not capable of manually operating a device UE 24, e.g. by sending an emergency indication (and/or emergency credentials) during setting up a call to device UE 24, by calling a special number related to the device UE 24's phone's phone number or by sending a USIM application/service commands or (secret) dial codes to device UE 24, or by sending a public warning signal or broadcast messages (e.g. via multicast/broadcast service framework) or SMS with special code. Alternatively, the device UE can be configured to answer all the incoming audio/video/data calls initiated from the first responder and bar all the other calls for a stipulated duration of time. Alternatively, if the device UE 24 supports push-to-talk functionality, a message may be sent over one or more frequencies or by sending one or more messages supported by one or more push-to-talk systems (e.g. Mission Critical Push-to-Talk as defined by 3GPP TS 24.379).

Alternatively, a first responder may use device 20, or access device 22, or a first responder UE that may be connected to the first responder network operated by/accessible through device 20 and/or access device 22, to set up a sidelink/PC5 to a ProSe application/service offered by device UE 24 for such purposes (e.g. a ProSe application/service that enables establishing a connection to device UE 24 that may be automatically accepted (without showing any pop-up/user confirmation dialog) and/or a ProSe application/service for configuring the device by sending configuration messages (e.g. to override some restrictions/policies or to prevent notification pop-ups on device UE 24 that would need to be approved through user action) and/or a ProSe application/service to fetch the device's location and/or a ProSe application to request device UE 24 to set up a connection to the first responder network). For example, this may be achieved by using PC5 direct communication as specified in TS 23.304 between device 20, access device 22, or the first responder UE and the device UE 24 for that particular application/service (e.g. a ProSe configuration service or ProSe emergency service).

In an example, a device UE 24 may have been configured with a special permission that may override/reconfigure other permissions/restrictions/policies or prevent pop-ups, possibly together with a password, key or other credential that may need to be provided to the device (e.g. through one of the above mentioned ways to establish a connection and/or after such connection is established) to confirm/enable/allow such special permission. Alternatively, device UE 24 may have been configured with a password, key or other credential with which it is possible to override/reconfigure a set of permissions/restrictions/policies. In another example, the user of device UE 24 may also have agreed beforehand to provide permission to override/reconfigure other permissions/restrictions/policies or prevent pop-ups e.g. under certain conditions (such as an emergency/MCI event) by storing the consent to such special permission in the Unified Data Manager (UDM), Unified Data Repository (UDR), Home Subscriber Server (HSS) of the device UE 24's home network. The first responder may use device 20, or access device 22, or a first responder UE may request information that allows it to verify if such special permission is given or valid, or request to confirm that such special permission is given or valid, or request to be authorized to access such permission, or be authorized to connect to device UE 24 based on this permission, or be authorized to allow device UE 24 to connect to/through the first responder network, access device or first responder UE. Such request for information, verification or authorization may for example be made during connection setup with device UE 24 or during device UE 24 registering/setting up a connection with the first responder network, access device or first responder UE, by connecting to the respective Unified Data Manager (UDM), Unified Data Repository (UDR), Home Subscriber Server (HSS), e.g. through an NEF, or roaming connection (e.g. between the AMF of first responder network and a UDM in device UE 24's home network), or through a connection with a Public Safety Answering Point (PSAP), which may have access to the respective permission data or may have the ability to override/authorize the respective permission on behalf of the home network of device UE 24 or in cooperation with the home network of device UE 24 or which allows the first responder network to set up a connection with the home network of device UE 24 (e.g. to connect to its UDM) via the PSAP, whereby the PSAP may act as relay/bridge between the two networks to enable exchange of information. In another scenario, additional information about the user of device UE 24 may be retrieved from the UDM/UDR/HSS (e.g. name of the subscriber of the subscription linked to device UE 24, telephone number, emergency contact numbers). Using the telephone number and/or the emergency contact information (which may have been added to the information in the UDM/UDR/HSS, or which may have been listed as an emergency contact on the respective device UE 24's SIM card, non-volatile storage, or wearable connected to the device UE 24), the first responder network (or home network of device UE 24, or the PSAP) may send a request/notification the device UE 24 or the devices linked to the emergency contacts' phone numbers to “unlock” the device and override certain permission/policy settings of the device UE 24 ((such as the location privacy indicator settings), or to override the security lock on the device UE 24 or SIM card, or to accept an incoming invitation (e.g. to connect to the first responder network), connection request (e.g. to fetch information of the device such as its location), position estimation request, user identification request or fetch a SIM profile or authorize these actions to be taken on behalf of the casualty. Such invitation may e.g. be an SMS message with certain keywords or character codes/combinations or identity information, and which may come from a pre-configured telephone number (e.g. operated by a government agency, e.g. a PSAP), and may include identity information of the first responder network and may include some emergency credentials. After confirming a request/notification to “unlock” the device UE 24 (e.g. by responding to the message and/or by providing credentials to unlock the devices (e.g. in the response message) and/or by the receiving device to send a message (e.g. SMS) message to device UE 24 with certain keywords or character codes/combinations or identity information, and which may come from a pre-configured telephone number, such as a telephone number of one of the emergency contacts stored on device UE's SIM card, non-volatile storage or wearable device connected to device UE 24), the first responder network may be authorized access to the device UE 24's information such as its location, and/or the device UE 24 may initiate connection setup to the first responder network. Additionally or alternatively, upon the device UE 24 receiving a notification to “unlock” the device and/or receiving a particular message (e.g. SMS with certain keywords or character codes/combinations or identity information, and which may come from a pre-configured telephone number (e.g. operated by a government agency, e.g. a PSAP)), the device UE 24 may fetch the list of emergency contacts (e.g. a set of telephone numbers) from the device UE's SIM card or non-volatile storage or wearable connected to device UE 24, and automatically send a message (e.g. SMS) to the telephone numbers of those emergency contacts including a request/notification to “unlock” device UE 24.

The device A 20 may store information about the identified casualties in a database, and also the devices associated with those casualties (e.g. mobile phones, wearable monitoring devices, together with their identifiers, telephone numbers, personal data, emergency contacts, severity of their injuries, triage colors, electronic patient records that may be received, their current location, etc.) and allow easy filtering and provide an overview of all casualties with a certain severity and make it easy to contact them as a group or individually.

The one or more devices UE 24 may comprise a subscriber identification module 242 (e.g., a universal integrated circuit card (UICC) containing a subscriber identity module (SIM) card or a Universal Mobile Telecommunications System (UMTS) SIM (USIM) card) that is associated with a mobile operator's subscription, a radio module 244 for wireless communication, and at least one user application (app) 246. The devices UE 24 may be configured to support sidelink communication links 24SL between themselves.

As an additional option, if a device UE 24 is still connected to an existing PLMN operating in the same MCI area, the first responder network 200 (e.g. device A 20) may send a message (e.g. via data connection) via an application server (e.g. on the internet or operated by the Home PLMN) to a particular emergency application running on the device UE 24, that allows the device UE 24 to set up an emergency call (or RLOS) connection to the first responder network 200 either directly or routed via the Home PLMN and/or provide location information to the first responder network 200 via the Home PLMN.

The device A 20 may be configured to receive device identity information from the one or more devices UE 24 and to determine the user identity associated with the device identity of the devices UE 24, e.g., based on a mobile operator's subscription information or possibly by user identity information (e.g. digitally signed identity card, name/E-mail/contact address, fingerprint scan) provided by the device UE 24 (e.g. during registration or through a subsequent PDU session) in addition to device identity information. As mentioned before, information about the user identity may also be requested from or provided by the home network of device UE 24, e.g. upon device UE 24 registering to the first responder network, whereby the first responder network may request the home PLMN of device UE 24 to provide user identity related information (e.g. subscription information, name of subscription owner, telephone number, emergency contacts) and/or location information of device UE 24. To this end, the first responder network may need to provide emergency credentials (e.g. a digital certificate signed by a first responder agency or the government) with which it can prove to the home PLMN of device UE 24 that it involves an emergency situation and that hence it is important to provide device identity information of device UE 24 (e.g. based on SUCI that may be provided by the responder network to the home PLMN, which may in return provide user identity information or location information about device UE 24). Alternatively, the first responder network may request information about user identity related information and/or location information of device UE 24 via the NEF of the home network of the home PLMN. Similarly it may need to provide emergency credentials to be able to make such request and securely exchange user identity information or location information about through the NEF. Optionally, at least some of the devices UE 24 (e.g., that are identified and preconnected to a default network connection but are not personalized to a specific first responder's network preferences) may be distributed to first responders when they arrive at the MCI area. So, there may not be a mapping to a specific person in the mobile operator's subscription database. In such a case the device UE 24 can be manually linked to the first responder by fetching the details of the FRDB 28 via the device A 20, by securely and confidentially entering the user information (e.g., manually scanning the government issued first responder ID card, or scanning of biometrics including but not limited to face, fingerprints and iris data) at the device UE 24. The information fetched from the FRDB 28 can be used by the device A 20 to personalize the device UE 24 for a specific first responder depending on their role in the MCI area. The provisioning of network preferences may be done using a UE Configuration Update or UE Parameter Update procedure or by using a remote provisioning server (e.g. as specified under root discovery service specified in GSMA—SGP.22 RSP Technical Specification).

Alternatively, a fully connected and personalized device UE 24 of a first responder A can securely fetch and download the network configuration and preferences (e.g., subscriber information module SIM profile) of a first responder B to a disconnected and non-personalized UE 24 via an out-of-band channel (e.g. NFC or peer to peer Wi-Fi, Bluetooth connection) by identifying the first responder B in a communicatively coupled FRDB server based on the user identity information collected securely and confidentially at the device UE 24 of the first responder A.

The first responder network 200 may thus be established by the devices A 20, B 22 and UE 24 (e.g., as described in 3GPP specifications as a 2G/3G/4G or 5G network, including but not limited to non-3GPP access of unlicensed wireless spectrum such as Wi-Fi, Bluetooth, industrial, scientific and medical (ISM) bands or the like). The infrastructure of the first responder network 200 may follow specifications of corresponding technology with which the network chooses to operate its devices A 20, B 22, and UE 24.

Furthermore, all devices UE 24 deployed by a first responder in the first responder network 200 can typically operate in either one of their ISM bands, whereas deployment of private mobile user devices (i.e., BYOD (“bring your own device”) user devices) in the MCI area is limited to radio technologies available on the user device.

Thus, the proposed first responder network 200 may enable automatic identification and registration (onboarding) of pre-registered devices UE 24 (e.g., cellular devices) of first responders onto the first responder network that can be used in an MCI area from the network side (i.e., the device A 20). Furthermore, deployed devices UE 24 can be prevented from connecting to a public network during the MCI event, and unauthorized devices can be prevented from registering onto the first responder network 200. If pre-registered, the devices UE 24 could have been provided with necessary configuration steering-of-roaming information or similarly a prioritized list of preferred Non-Public Networks and credentials beforehand to facilitate registration to the first responder network 200.

Furthermore, the proposed first responder network 200 may allow automatic registration of unregistered devices directly by verifying the identity linked to the user (e.g., through a cellular device platform, such as the Global System for Mobile communications Association (GSMA) IMEI platform) or via pre-registering first responder devices in the deployed infrastructure (e.g., FRDB 28 of the core network) from the network side. If no credentials are needed, the first responder network 200 could offer a kind of emergency or RLOS connection instead of fully registering and authenticating an unregistered device.

As described above, wireless communication devices carried by personnel from a different region (e.g. neighboring region fire brigade) could be considered as inbound roaming devices, or a first responder's device may be capable of supporting sidelink communication and thus be able to set up an ad-hoc/mesh-type network, or wireless communication devices could each run a group application and could thus all be added to the first responder network 200 in one go, or one of the group of devices could act as an authenticator for other devices from the same group that are trying to register, or an additional verification check could be added based on the capabilities of a wireless communication device.

Additionally, the proposed first responder network 200 (e.g., device A 20) may allow automatic authorization and registration of base station devices (e.g., devices B 22) from various emergency services (e.g., fire, health and police departments) and other public and non-public network operators. A base station device can also be an IAB device (e.g., as specified by TS 38.174 Integrated access and backhaul radio transmission and reception), where the access device B 22 of the first responder network can act as a IAB donor to initiate a first radio link establishment with the IAB device (e.g., via S1/NG interface security and integrity protected by IPSec using the hardware root of trust located in the IAB device). Additionally, the IAB device can be equipped with id, private/public key pair, manufacturer certificates needed to establish a link between device B 22 (e.g., X2/Xn link) via special service (e.g. X2AP Global procedures as specified under 3GPP TS 36.423 X2 application protocol (X2AP)) in the device A 20 of the first responder network 200.

Moreover, the proposed first responder network 200 (e.g., device A 20) allows automatic fetching of capabilities of base station devices (e.g., devices B 22) to be registered into the first responder network 200.

In addition, the proposed first responder network 200 (e.g., device A 20) may allow automatic fetching of identity information (e.g., 5G_GUTI as specified in 3GPP TS 33.501 Security architecture and procedures for 5G system) of a device UE 24 (e.g., a wearable device) belonging to a casualty during the initial radio setup phase. A function (e.g., access and mobile function (AMF) as specified in 3GPP TS 23.501, System architecture for the 5G System) in device A 20 of the first responder network 200 can communicatively couple to a similar function of the home PLMN (of device UE 24) to securely fetch the user context (e.g. subscriber information) of the device UE 24 and device identity (e.g. IMEI) of the device UE 24. A casualty can be identified by matching the device ID to a user information which may be stored in a common cellular device platform (e.g., GSMA IMEI platform) or by different network operators of the concerned device UE 24 or by a governmental agency. An AMF of the first responder network 200 could communicatively couple with the AMF/UDM/HSS of the home network (of device UE 24) to derive/transfer the context of the device UE 24 “(i.e. in order to provide such context information to the first responder network 200) which may include the permanent equipment identifier (PEI) which is the IMEI in 5G/3GPP.

In an example, wearable monitoring devices may be provided by first responders to the casualties or victims. These monitoring devices may already be pre-configured for the first responder network 200 and attach automatically. However, they are not yet linked to a particular person (or e.g. only to a temporary/anonymous person identifier, such as John Doe 1). In this case, some automatic identity matching with a closest nearby mobile phone or other wireless communication device could be made, e.g., by measuring the distance between the monitoring device and the mobile phone or measuring the distance between the first responder's wireless communication device and the mobile phone (whereby the first responder's mobile phone may be used to link the two devices together). If the mobile phone is registered and the identity of the casualty or victim can be determined (e.g. using one of the mechanisms described earlier), then it is also clear to which person the output of the monitoring device belongs to. Alternatively or additionally, a picture of the casualty or victim could be uploaded (e.g., to the monitoring device, mobile phone of the first responder and/or to the network) to link the monitoring device to a particular casualty or victim. The color of the triage tarp or the color of a label provided to the victim may also be uploaded to indicate the severity of the injuries of a patient. This information (e.g. the color of the triage label) and/or a position of the device could be regularly broadcasted to enable easy tracking of the casualties. Alternatively, a copy of the casualty's or victim's emergency information in the mobile phone (e.g. stored locally on the mobile phone, or an identity for an electronic health report (EHR)) may be read out by near field communication (NFC) or vocally or visually provided to the monitoring device or mobile phone of the first responder, which could upload this information to the network. Note that NFC in monitoring device or first responder's mobile device could also be used to provide network credentials to the casualty's or victim's mobile phone to allow it to connect to the first responder network 200.

In addition, if a person is moved to a different triage area (e.g. condition gets more severe), then the wireless communication devices for that person (e.g. mobile phone or wearable monitor or location tag) may get updated to broadcast a different color. The moving of a person may also be detected by a camera in a drone or access device, or through a location service (i.e., if the location of a casualty now indicates a different geographical area, e.g. covered by another color tarp). The wireless communication devices may be re-invited or trigger/requested to connect to the first responder network 200, and may be requested or updated to attach to a different slice (e.g., if more resources are needed for the monitoring device for more critical patients, or if additional monitoring devices, e.g. a 12-lead ECG, need to be attached to the casualty).

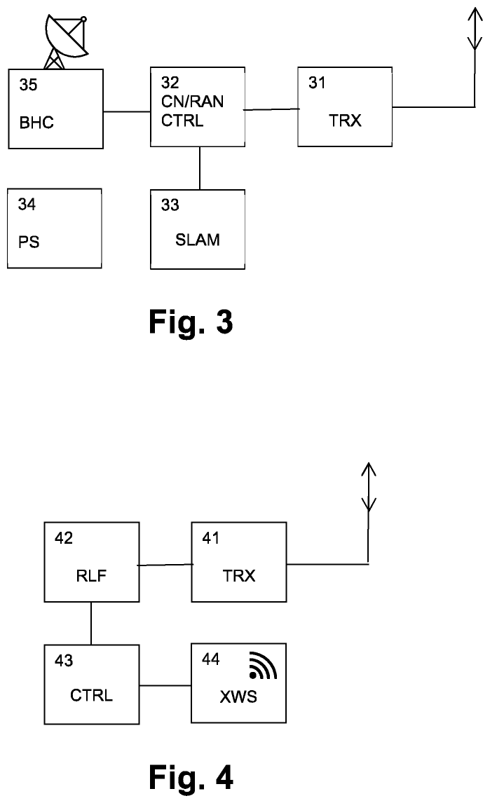

FIG. 3 schematically shows a block diagram of a network controller device (i.e., device A) according to various embodiments.

The device A may be provided on a first-arriving emergency vehicle (e.g., medical care vehicle, firetruck, unmanned aerial vehicle (UAV)) of first responders of an MCI event and may comprise a power supply (PS) unit 34 connected to an uninterrupted power supply of the emergency vehicle.

The device A may further comprise a transceiver (TRX) 31 for wireless transmission and reception to/from the first responder network 200, and at least one controller (RAN CTRL) 32 that provides the network controller function 202 of FIG. 2 and that is configured to provide capabilities of a radio access network (RAN), e.g., equivalent to a base station of a cellular network. The controller 32 may be configured to set up an integrity-protected and secure communication channel for communicatively coupling to devices B, devices UE, the central identity server, the first responder database and other services external to the described system, and to provide the identity service function 204 of FIG. 2.

Furthermore, the device A is likely to be a base station device or other network access device coupled with functionalities of a core network and may further comprise a backhaul communication module 35 that may provide a direct satellite link as a backhaul communication to enable internet access and a data path to backbone networks. Other means of backhaul communication such as optical wireless communication (OWC) may also or alternatively be deployed in the device A. In an example, the device A can be configured to provide a standalone end-to-end wireless system (e.g. cellular network comprising of hardware and software necessary for a base station, core network and a backhaul network to provide internet and a data path) either off-the-grid connection (e.g. deployed as a small cell system comprising of a non-public-network) or via the existing telecommunication grid (e.g. deployed with an existing mobile network operator (MNO) backbone). Furthermore, the device A may comprise a simultaneous localization and mapping (SLAM) module 33 (which corresponds to the SLAM function 206 of FIG. 2) with sensors and computational systems (e.g., Radar, Lidar subsystems etc.) for judging the MCI area and deciding on the number and type of devices to be deployed in the MCI area.

FIG. 4 schematically shows a block diagram of an access device (i.e., device B) according to various embodiments. It may be an unmanned robot device including but not limited to drones and rovers, or e.g. access device mounted to an ambulance.

The device B may comprise a transceiver (TRX) 31 for wireless transmission and reception to/from the first responder network (e.g. acting as a gNB or Wi-Fi Access Point) and may comprise a relay functionality (RLF) 42 that provides the capabilities of a relay node (e.g., as described in 3GPP TS 24.334 V16.0.0 (2020 July): “Technical Specification Group Core Network and Terminals; Proximity-services (ProSe) User Equipment (UE) to ProSe function protocol aspects”) or as described in 3GPP TS 38.174 V16.3.0: “Technical Specification Group Radio Access Network; NR Integrated access and backhaul radio transmission and reception, which can be controlled by the device A at a specific location confined to the MCI area.

Furthermore, the device B comprises a controller (CTRL) 43 configured to provide capabilities for accessing the wireless first responder network provided by the device A. The controller 43 may further be configured to set up an integrity-protected and secure communication channel for communicatively coupling to the device A and devices UE.

In addition, the device B may also be equipped with an exclusive wireless system (XWS) 44 (e.g., Wi-Fi, Bluetooth, LoRa etc.) in addition to the radio access functions required to access the first responder network provisioned by device A. In an example, the exclusive wireless system 44 can be used for a separate sidelink communication link both from device B to device A and between devices B and to enable more accurate positioning (e.g., by sending also signals from those other radio access functions to a hybrid positioning module in a location service operated by network 200).

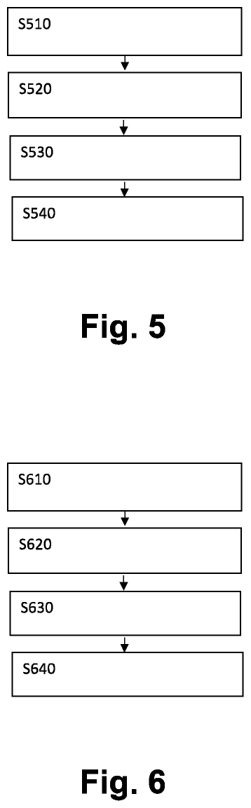

FIG. 5 schematically shows a flow diagram of a first responder network deployment procedure (e.g., at a device A) according to various embodiments.

Upon the first initiation of the device A in an MCI area, a pre-determined number of device B (and/or other devices, such as drones dedicated to the task of mapping, that do not provide cellular access) may be deployed on to the field to survey and map the MCI area and to calculate the severity and scale of the MCI area, e.g., at the SLAM module 33 of FIG. 3 (step S510). In step S520, deployed devices B, communicatively coupled to the device A via a wireless link, update their measurement parameters (for e.g. total area in square meters, structural anchor points, number of victims etc.) to a local SLAM service that is deployed either on the device A or on a cloud communicatively coupled via the device A and controlled by the SLAM function 206 of FIG. 2 or the SLAM module 33 of FIG. 3. In step S530, the SLAM service may predict a total number of devices B needed and their location in the fields to fully cover the MCI area either with or without human supervision. The procedure in step S530 may be supported by using machine learning models.

Based on the result of the SLAM service, device(s) B may be deployed or removed from the field based on the predicted estimate of the number of first responders that are needed to attend to the particular MCI event.

More specifically, in step S530, the SLAM service may estimate landmarks in a given geographical area based on sensor measurements obtained from sensors on the device B 22 and/or other devices dedicated to the task of mapping. Landmarks may be uniquely identifiable surfaces/objects whose characteristics are estimated by sensors. For example, a concrete wall of a high raised building can be a landmark. Dimensions and refractive properties of such landmarks can be estimated by using e.g. laser scanners or other optical measuring devices present in at least some of the deployed devices B 22 and/or other devices dedicated to the task of mapping.

While determining the boundaries of the landmarks using sensors on the devices B 22 and/or the other devices dedicated to the task of mapping, the SLAM service at the device A 20 may build a virtual 3D map of the MCI area using the sensor data obtained from the sensors on the devices B 22 and/or other devices dedicated to the task of mapping.

In addition to the location and mapping measurements, a wireless radio provided on the device B 22 may simultaneously measure wireless link quality parameters (including but not limited to received signal strength, channel state information, reference signal reception power) of the radio signal between the device A 20 and the device B 22 in its current location and between the devices B 22 and the devices UE 24 attached to devices B 22 covering the MCI area (and their location). The SLAM service or other network function (such as NWDAF) on device A 20 may receive this wireless link quality information from each of the devices B 22 at a configurable sampling rate, to determine white spots of radio signal in a target geographical area.

The sensor measurements and wireless link quality parameters between the device A and the devices B 22 and/or other measuring devices can be used to predict a precise location for placement of an access point (i.e. device B 22) such that a full and reliable coverage of the wireless system of the first responder network 200 can be ensured. Based on this precise prediction of device B placement, the device A 20 may deploy additional access device(s) B 22 and/or relay devices to enhance coverage in white spot areas of radio links between the device A 20 and devices UE 24 in the field. If there are redundant devices B 22 in a location where there is good link quality, such redundant devices B 22 can be removed (e.g. retrieved from the location).

In an MCI area, surroundings can change dynamically due to the disastrous nature of the event. Big buildings can collapse into rubbles and large rubbles can fill open grounds. New metallic rubbles in open ground can change the environment both into a more favorable and less unfavorable situation for wireless communication. In such constantly changing environments, the SLAM service will receive continuous measurement parameters from sensors and wireless radio of devices B 22 and/or other devices dedicated to the task of mapping to update the SLAM service and ensure high reliability and full coverage for wireless connectivity during the entire duration of the triaging process in the MCI area.

Alternatively, the SLAM service could use an existing map (e.g. OpenStreetMap) of the target geographical area as a starting point for determining the number of devices B 22 and update the existing maps with the measurement data obtained from the devices B 22 and/or other devices dedicated to the task of mapping. Machine learning models can be used to predict both minor environmental changes (e.g. collapsed compound wall) and major environmental changes (e.g. collapsed multistorey building) based on sensor data and determine anchor points (devices B 22 and/or other devices dedicated to the task of mapping) based on the new landmarks obtained from the SLAM service.

Alternatively, when there are no large landmarks present in the MCI area (e.g., a flight crash in a grassland, where there are no buildings), wireless link quality measurements can be used as an indication or function of distance between the devices B 22 and the device A 20. In an example, sensors on the device B 22 can be used for granular distance estimation between the device A 20 and the device B 22 and wireless link quality can be mapped as a function of distance between the device A 20 and the device B 22.

Finally, in step S540, the device A 20 registers a device UE 24 detected and invited or triggered/requested by a device B 22 to connect to the first responder network 200 e.g. in case the detected device UE 24 is a predetermined/pre-registered wireless communication device of a first responder. To achieve this, a device identity information received from the detected device UE 24 is used to determine a user identity associated with the received device identity information of the detected device UE 24 and to check whether the user is a registered first responder or the detected device UE 24 is registered first responder device. Alternatively, as described above, wireless communication devices carried by personnel from a different region (e.g. neighboring region fire brigade) could be considered as inbound roaming devices, or a first responder's device may be capable of supporting sidelink communication and thus be able to set up an ad-hoc/mesh-type network, or the wireless communication devices could each run a group application and could thus all be added to the first responder network 200 in one go, or one of the group of devices could act as an authenticator for other devices from the same group that are trying to register, or an additional verification check could be added based on the capabilities of a wireless communication device.

Furthermore, a device B 22 may be used to sense signals of devices UE 24 (e.g. mobile phones) of casualties or victims (e.g. under the rubble).

FIG. 6 schematically shows a flow diagram of a first responder network localization and mapping procedure (e.g., at a device B) according to various embodiments.

In step S610, a device B is deployed in a target field of the MCI area based on an initial determination of the device A. Then, in step S620, the deployed device B may perform measurements to derive measurement parameters (for e.g. total area in square meters, structural anchor points, number of victims etc.) in the target field of the MCI area.

Then, in step S630, the obtained or updated measurement parameters may be transmitted to the device A. Furthermore, the deployed device B invites or triggers/requests devices UE located in the target field to register to the core network operated by the device A.

In an optional step S640, the deployed device B, communicatively coupled to the device A, may be controlled by the device A to act as a relaying base station (e.g. as described in 3GPP TS 36.216 “Evolved Universal Terrestrial Radio Access (E-UTRA); Physical layer for relaying operation” or in 3GPP TS 38.174 “Integrated Access and Backhaul (IAB) radio transmission and reception”), which can relay received messages (e.g. extract data from a received signal, apply noise correction techniques and retransmit a new “clean” signal in its own coverage zone) from a device UE such that the signal coverage of device A can be extended to the entire field of the MCI area without overloading resources of the device A.

The device B may be configured to automatically switch on or off its relay functionalities, e.g., by continuously monitoring the load capacity of the first responder network 200 and optimize the network topology in coordination with device A.

Alternatively, an authorized network controller (either an automated software function or a human) may interact with the device A (e.g. as specified in 3GPP TS 29.522: “Network Exposure Function Northbound APIs”) to manually override the network topology and alternating the relaying functionality of the device B.

Then, in an optional subsequent step (not shown on FIG. 6), the first responder network (e.g. operated by device A) may perform device identification, user identification, positioning, counting of devices, provide emergency communication services, or other operations for/on behalf of the devices UE that registered to the first responder network (through device B).

In an example, to identify a particular first responder as user of a device UE, a user A, who is likely to be a pre-registered first responder, arrives at the MCI area with a device UE, which has a device identification (devID) and an IMSI that is linked to the particular user A at a centralized server (e.g. as specified under root discovery service specified in GSMA—SGP.22 RSP Technical Specification). This centralized server may be communicatively coupled to the first responder database (cf. FRDB 28 in FIG. 2), such that upon identification of the device identification and the IMSI of the device UE at the device A, the IMSI can be used to verify the first responder at the first responder database for example by a biometric identification including but not limited to facial, fingerprint and/or iris data of the user A captured at the device UE.

Alternatively, a personal identification number (PIN) code can be used to identify the user at the first responder database. In yet another alternative, a user interface (UI) prompt may be triggered at the device UE by the first responder database after verification of registration of the device UE of a first responder, to identify a user via his/her own choice of verification method. Upon successful identification of the user and the device UE, the device A can automatically register (onboard) the device UE to the first responder network.

Yet another alternative to identify a user on the device could be to use a government-issued radio frequency ID card (e.g., NFC based first responder ID) on the device.

Alternatively, the device A can limit the device UE to neglect other mobile network operators in the MCI area and strictly connect only to the services offered by the device A for a time interval that is pre-determined for a particular MCI event or set by the SLAM service on device A upon surveying the MCI area.

In yet another example, after initiation of a first responder network at device A, a first responder A can register (onboard) an unregistered device UE of another first responder B registered at the first responder database, by firstly self-registering themselves to the first responder network via device A and authorizing the device UE of first responder B to register to the network services offered by device A. Then, the device identification (devID) of the device UE of the first responder A is captured at the first responder database together with the registration details of the first responder B such that a legitimate authorization record is available for a given MCI event.

In case a first responder B gets injured in an MCI event after arrival at the MCI field, a first responder B changes his/her designation at the scene, the device UE of a first responder B is handed over to another first responder, or a first responder B has to leave the MCI area for unprecedented reasons, the device UE of the first responder B may be deregistered from the first responder database as a first responder directly by the device UE of the first responder B or via the device UE of the other first responders present in the MCI area. The device identification (devID) of the device UE of a first responder who is deregistering the first responder B from the first responder database may then also be captured at the first responder database together with the deregistration details.

In yet another example, device B may be shared by different emergency services (e.g., medical, fire and police drone) to be used in an MCI event as an alien access device of the first responder network. The device A may be able to identify and authorize the alien device B to securely fetch the capabilities of the device B (e.g., battery, radio resources, antenna) from the alien device B or a service in an exclusive emergency service network which has information about the capabilities of the alien device B. This information can be used by device A while planning the deployment of access devices in the MCI area.

In another example to identify a casualty/victim as user of a device UE, a registered device UE of a casualty, likely to be a wearable device or a mobile phone that is powered on, may have an unscathed radio frequency (RF) module (e.g., a 3GPP radio module) with an IMSI stored in a subscriber identity module (e.g., eSIM). The IMSI may be identified by a device B or device A (e.g., by initiating a scan of IMSI in proximity of the device B, e.g. using an IMSI scanner) or derived from the temporary identifier (e.g. 5G GUTI) assigned to a device UE 24 by home PLMN or e.g. by the first responder network (operated by device A) to ask its UDM or the UDM of the home PLMN of the device UE 24, to deconceal the SUCI that may be received from device UE 24 upon registration. Upon identifying the presence of a device UE of a casualty in the vicinity, the device A or device B may (possibly automatically) connect to the central identity server to communicate the subscriber details (e.g., IMSI) and fetch the information of the person linked to the device UE. The device A may be communicatively coupled to service providers (e.g., mobile network operators) and can register (onboard) the device UE of the casualty to the first responder network and use e.g. its location service and/or devices B to automatically triangulate the location of the casualty or request the location of the device UE 24 from a location service of the home network of device UE 24.

Alternatively, an identity service running on the device A may coordinate with a similar identity service of the network provider (e.g. home PLMN) of the device UE of a casualty (e.g. by the first responder network setting up a connection via the NEF or to the UDM of the home PLMN of the device UE and request the home PLMN to provide user identity information related to the device identity (e.g. SUCI) that may be provided by the device UE during registration), to fetch relevant patient or user information details including but not limited to a name of the subscriber of the subscription related to the IMSI/SUPI, emergency contact details, or an electronic medical record identity (EMR ID) of the user (i.e. victim/casualty) that owns/operates the device UE. This identity service could securely access IMSI details (e.g., as specified by GlobalPlatform Card specification v2.2) from the subscriber identity module stored in the device UE of a casualty. The device A of the first responder network may then securely transport the subscriber details to the network provider of the device UE of a casualty in an integrity protected communication channel.

In yet another example, a device B or device A upon identifying a device UE in the proximity shall be able to detect the presence of vital sign sensors on the device UE (e.g., by capturing the device class of the device UE) by a pre-specified device class identifier for a device classified as a vital sign device (e.g., a smart watch integrated with vital sign sensors such as heart rate sensor or the like) upon registering or even before registering (onboarding) the device UE to the first responder network. If the device B would be a UE itself (e.g. from a first responder), then this could be done through a sidelink interface (e.g. PC5 of ProSe) which may provide a list of its capabilities or device class or a specific ProSe service through discovery or during or after sidelink connection setup. Also, the device B could set up a sidelink (e.g. PC5) connection to the device UE to communicate directly with the victim's device, e.g. to fetch vital signs information.

Upon detecting the presence of a device UE equipped with a vital-sign sensor, the device B may coordinate with the device A to enable a virtual sub-network under the first responder network such that a device UE of a secluded casualty can be provisioned with network credentials of the first responder network to thereby register (onboard) the device UE to the virtual private sub network. Upon successful registration, network services of the first responder network can access the device UE to enable network specific services on the device UE including but not limited to localization, device power management, and application-specific services including but not limited to fetching data from vital sign sensors, installation of network-optimized applications for first response operations.

Alternatively, the device A can communicatively couple to a network service provider (e.g. home PLMN) of the device UE of the casualty to enable the device UE to roam onto the first responder network and carry out network and application specific services. The PLMN of that device UE may offer an interface or application programming interface (API) via a NEF to enable a first responder network to send such requests, for specific devices UE and under specific authorization and/or privileges.

In yet another example, an unscathed vital sign equipped device UE of a casualty can be used to track the health status of the casualty after having been communicatively coupled to the first responder network.

Upon detecting the presence of a vital sign equipped device UE (e.g., a smart watch), a prioritization service on the device B may be used to prioritize the device UE over unequipped device UEs (e.g., smart phones) that can be registered to the first responder network, such that upon registering the device UE, the device B can securely fetch the latest vital signs from the device UE of the casualty with optimized balance in the first responder network.

In yet another example, devices A and B may operate multiple network slices, each with their own performance characteristics.

To summarize, a wireless communication system for first responder networks has been described that can securely register (onboard) a variety of wireless devices to ensure a quicker response time in the MCI field. Existing wireless devices belonging to both triage officers and victims on the MCI field can automatically be registered to a first responder network for automated tracking, identification and determining position of first responders and casualties, emergency communication between first responders and casualties, and to enhance coverage in the MCI field. Expansion of a wireless infrastructure of the first responder network can be enabled by securely registering alien central nodes (e.g. base stations) on an on-demand basis.

While the invention has been illustrated and described in detail in the drawings and foregoing description, such illustration and description are to be considered illustrative or exemplary and not restrictive. The invention is not limited to the disclosed embodiments. It can be applied to various types of devices UE, such as mobile phone, vital signs monitoring/telemetry devices, smartwatches, detectors or other type of portable device. The term geographical area used throughout the description may interchangeable be used for any spatial area or volume determined by a set of coordinates (absolute or relative to a reference point/device) or a set of minimum/maximum distance(s) to a reference point/device. A geographical area may be outdoors as well as indoors.

The wireless communication devices (device UEs) can be different types of devices, e.g. mobile phones, vehicles (for vehicle-to-vehicle (V2V) communication or more general vehicle-to-everything (V2X) communication), V2X devices, IoT hubs, IoT devices, including low-power medical sensors for health monitoring, medical (emergency) diagnosis and treatment devices, for hospital use or first-responder use, virtual reality (VR) headsets, etc.

The device A may be any network access device (such as a base station, Node B (eNB, eNodeB, gNB, gNodeB, ng-eNB, etc.), access point or the like or e.g. a PC/portable/server device that may offer network control or core network functions) that provides a geographical service area.

Furthermore, at least some of the above embodiments may be based on a 5G New Radio (5G NR) radio access technology. Specifically, the relay functions enable multi-hop indirect network connections for remote communication devices to achieve improved coverage for communication devices in the first responder network and improved low-power operation for IoT communication devices specifically.

Furthermore, the invention can be applied in medical applications or connected healthcare in which multiple wireless (e.g. 4G/5G) connected sensor or actuator nodes participate, in medical applications or connected healthcare in which a wireless (e.g. 4G/5G) connected equipment consumes or generates occasionally a continuous data stream of a certain average data rate, for example video, ultrasound, X-Ray, Computed Tomography (CT) imaging devices, real-time patient sensors, audio or voice or video streaming devices used by medical staff, in general IoT applications involving wireless, mobile or stationary, sensor or actuator nodes (e.g. smart city, logistics, farming, etc.), in emergency services and critical communication applications, in V2X systems, in systems for improved coverage for 5G cellular networks using high-frequency (e.g. mmWave) RF, and any other application areas of 5G communication where relaying is used.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

The described operations like those indicated in FIGS. 5 and 6 can be implemented as program code means of a computer program and/or as dedicated hardware of the related communication device or access device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for supporting establishment of a wireless communication network, wherein the apparatus is configured to:
connect to a network controller device of the wireless communication network and provide wireless connectivity to wireless communication devices within a target geographical area;
receive information about the target geographical area;
receive from the network controller device information about a network configuration to setup a communication channel with wireless communication devices; and
invite or trigger wireless communication devices located in the target geographical area to register via the communication channel or other communication channel to a core network operated by the network controller device.

2. The apparatus of claim 1, wherein the apparatus is configured to restrict registration invitations or triggers to at least one of a predetermined group and/or type of the wireless communication devices, a network service and a network slice of the wireless communication network.

3. The apparatus of claim 1, wherein the apparatus is configured to receive information about the target geographical area, the target geographical area being an area smaller than the coverage area of an access device.

4. The apparatus of claim 1, wherein the apparatus comprises a relay node function that can be activated by the network controller device.

5. The apparatus of claim 1, further configured to perform measurements in the target geographical area and forward corresponding measurement parameters to the network controller device for prediction of a total number of access devices or relay devices or wireless communication devices needed in a mass casualty incident, MCI, or emergency area.

6. The apparatus of claim 1, further configured to include information about an emergency situation in an invitation signal or message sent to the wireless communication devices.

7. The apparatus of claim 1, further configured to fetch identity information of a wireless communication device and to identify a user of the wireless communication device by matching the identity information of the wireless communication device to a user information stored in a cellular device platform.

8. An access device for providing wireless connectivity to wireless communication devices in a wireless communication network, the access device comprising an apparatus of claim 1.

9. A wireless communication system comprising one or more wireless communication devices, an access device of claim 8 connected to a network controller device.

10. The system of claim 9, wherein the system is configured to provide device authentication via a coupling between the network controller device and an external device not registered to the wireless communication network.

11. The system of claim 10, wherein the network controller device is configured to connect to the external device over a local connection limited in range and provide a coupling to a core network of the wireless communication network in order to allow the external device to act as authenticator and/or a subscription owner registry for an inbound roaming device.

12. The system of claim 10, wherein the network controller device is configured to allow the external device to prove that an incoming roaming device belongs to a same network, facility, or group.

13. The system of claim 9, wherein the network controller device is configured to provide authentication and/or identification information to the external device so that a core network function of the external device can provide a local network registration function.

14. The system of claim 10, wherein the external device is a drone or mobile server device.

15. The system of claim 9, configured to exchange information between the wireless communication network and another wireless communication network for user identification, acquiring position information, or request a wireless communication device to connect to the wireless communication network, or to request an access device of the another wireless communication network to temporarily join the wireless communication network.

16. The system of claim 9, configured to identify and keep track of legitimate network authorizations and transactions in the wireless communication network and/or subscriber databases.

17. A method of supporting establishment of a wireless communication network, wherein the method comprises:
connecting to a network controller device of the wireless communication network and providing wireless connectivity to wireless communication devices within a geographical target area;
receiving information about the target geographical area;
receiving from the network controller device information about a network configuration to setup a communication channel with wireless communication devices; and
inviting or triggering wireless communication devices located in the target geographical area to register to a core network operated by the network controller device.

18. A computer program product comprising code means for producing the steps of claim 17 when run on a computer device.
